(19) United States
(12) Patent Application Publication
(10) Pub. No.: US 2025/0119435 A1
(43) Pub. Date: Apr. 10, 2025

(54) CLOUD-BASED CYBER SECURITY AND METHODS OF OPERATION

(71) Applicant: Darktrace Holdings limited, Cambridge (GB)

(72) Inventors: John Boyer, Cambridge (GB); Connor Trimble, Cambridge (GB); David Culemann, Cambridge (GB); Ciaran McKey, Cambridge (GB); Mihai Varsandan, Edinburgh (GB)

(21) Appl. No.: 18/908,111

(22) Filed: Oct. 7, 2024

Related U.S. Application Data
(60) Provisional application No. 63/542,708, filed on Oct. 5, 2023.

(51) Int. Cl. H04L 9/40

(52) U.S. Cl. CPC H04L 63/104; H04L 63/20

(57) ABSTRACT

A cyber security system is adapted to contextualize and visualize cloud architectures featuring ephemeral cloud assets with generation of a cloud asset remediation plan to group alerts for handling based on security team responsibilities.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### RELATED APPLICATION

This application claims priority under 35 USC § 119 to U.S. Provisional Patent Application No. 63/542,708, entitled “Cloud-Based Cyber Security and Methods of Operation” filed on Oct. 5, 2023, where content of this application is incorporated by reference herein.

### FIELD

Cyber security and in an embodiment use of Artificial Intelligence in cyber security.

### BACKGROUND

Cybersecurity attacks have become a pervasive problem for enterprises as many computing devices and other resources have been subjected to attack and compromised. A “cyberattack” constitutes a threat to security of an enterprise (e.g., enterprise network, one or more computing devices connected to the enterprise network, or the like). As an example, the cyberattack may be a cybersecurity threat against the enterprise network, one or more computing devices connected to the enterprise network, stored or in-flight data accessible over the enterprise network, and/or other enterprise-based resources. This security threat may involve malware (malicious software) introduced into a computing device or into the network. The security threat may originate from an external endpoint or an internal entity (e.g., a negligent or rogue authorized user). The security threats may represent malicious or criminal activity, ranging from theft of credential to even a nation-state attack, where the source initiating or causing the security threat is commonly referred to as a “malicious” source.

The migration to the cloud has marked an extraordinary transformation for many enterprises, and more often than not, a monumental undertaking in providing cloud-based security for an enterprise. While cloud-native approaches have facilitated swift innovation and unrivalled scalability, the addition of cloud-based security has created increased network security complexities, especially in the detection of cybersecurity threats (hereinafter, “cyber threats”) through identity and access management (IAM) in the context of behavioral analysis using “pattern of life” modeling and asset misconfiguration.

This increased complexity has caused difficulties in detecting cyber threat is due, in part, to the assets forming a cloud environment such as certain compute engines or services (e.g., processing logic), virtual machines, or the like. These cloud assets have short active lives, and thus, “pattern of life” analyses that utilize machine learning to establish a baseline or normal behavior for every network, device, and user within an organization, is less effective due to their ephemeral nature. Therefore, while capable of detecting cyber threats against the enterprise and determining preventive and/or remedial actions to counter those cyber threats, conventional cybersecurity products do not provide adequate insight for network security teams to comprehend cloud environments and how cloud workloads.

Moreover, these existing cybersecurity products fall short in providing the necessary level of visibility for those network security teams who understand the enterprise network, but are unfamiliar with its cloud assets. Many of these existing cybersecurity products merely catalogue cloud assets for an enterprise based upon cloud asset type, where there is a growing need to identify cloud assets, recover metadata (e.g., data, properties, metrics, etc.) associated with these cloud assets, and provide graphical representations of a cloud asset construct (and its relationship with other cloud assets) along with alerts directed to suspicious network and identity activity and different types of cloud asset misconfigurations.

Also, even when alerts are provided upon detecting of suspicious network and identity activity or potential misconfiguration issues, there may be multiple security teams enlisted to fix different cloud-based security issues. For example, one day, there may be ten security issues that are handled by three security teams. On the next day, there may be five security issues handled by different security teams or one former security team and one new security team. Hence, there is a lack of efficiency in triaging security problems within the customer cloud environment to be handled by different security teams empowered to handle specific network and identify activity and/or misconfiguration.

### SUMMARY

Methods, systems, and apparatus are disclosed for an Artificial Intelligence based (AI-based) enterprise security system. In general, the AI-based enterprise security system features a cloud security system communicatively coupled to a cyber security appliance. The cloud security system provides a security platform that may be deployed as part of an on-premises (hereinafter, “on-prem”) network to collect information pertaining to assets within the customer cloud environment utilized by an enterprise (hereinafter, “cloud assets”). The collection of the information associated with the cloud assets may be extracted from one or more cloud networks via a corresponding cloud provider application programming interface (API). Additional information pertaining to the cloud assets may be collected via sensors, logs, a specific cloud provider module, or the like. The cloud security system is configured to support an enterprise's security team by providing comprehensive visibility and an in-depth understanding of the customer cloud environment.

In general, one embodiment of the disclosure is directed to an Artificial Intelligence-based (AI-based) cyber security system, which may be configured with a cloud security system operating in accordance with an “architecture-first” approach. This approach leverages metadata and other factors to represent architectures as aggregations of assets in the cloud environment based, at least in part, upon one or more of the following factors: i) known patterns of communication between devices, ii) asset and policy configuration, and iii) interaction of user or identify & access management (IAM) roles. These factors are ascertained from metadata available to the cyber security system, which supports new features and enhancements to increase or improved operability of the AI-based cloud security system.

According to one embodiment of the disclosure, the cloud security system provides improved modeling for certain architectures represented as cloud-based devices by collecting additional data (e.g., metadata) associated with these architectures using API requests, which may be relied upon to alter security policy configurations supported by the cloud service (e.g., AWS security policy configurations). Such altering is targeted to improve the accuracy and/or effectiveness of actions conducted by the cloud security system in response to detection of a cyber threat or detection of normal operations.

For example, operating with a cloud service such as AWS (Amazon Web Services) for example, the cloud security system may be configured to model the cloud-based components more accurately by utilizing metadata collected from API requests. The metadata may include data pertaining to what containers are in Kubernetes and corresponding workloads, kinds of processor instances (e.g., EC2, etc.) that are utilized for the cloud-based device, or the like.

Herein, with respect to the cloud security system, additional and enhanced features are directed to the following:

Cloud asset enumeration—may generally involve propagating (crawling) around using the AWS API to gather account data to generate a list of every asset (e.g., instance, process, task, etc.) operating in the cloud environment as associated with the user. The list of assets are formulated by analytics of the structures (e.g., how the assets are linked based on security policies, user, or access permissions (roles); network rules; actual traffic seen by the cloud security system, network rules, etc.

Modelled architectures—may generally involve modeling improvements based on metadata obtained through API requests as described above.

Cost discovery—may generally involve using one or more cloud services' APIs (e.g., AWS API(s)) to acquire statistics about individual assets and their associated costs. The assets can be prioritized to identify “high” priority assets based on assigned costs for each asset and/or architecture construction. For instance, the cost discovery feature assists in identifying assets that may require increased security based on their higher priority as a cloud-based device as well as identify “orphaned assets,” namely assets that don't fit into the current cloud architectures and are costly to maintain.

Flow log analysis for visibility—may generally involve a deviation as prior cloud security system focused on deep packet inspection, with no support of flow logs because flow logs to not provide sufficient information for optimal operability of pattern of life monitoring. However, given that certain types of cloud-based components may not support deep packet inspection (or clients may be hesitant to deploy such operability due to mirroring costs), the cloud security system is further configured to support flow log analyses for basic pattern of life ingestion. For instance, CSPM or KSPM management are accessing cloud assets against frameworks to determine whether the assets are compliant with best practices.

Entitlement management/enumeration—may generally involve access policies and role permissions. In particular, before user monitoring is conducted, a user can be monitored as to access availability and identify when the users are over provisioned. This is to ensure appropriate role permissions to improve overall security of user accounts associated with a cloud service.

Other features include real-world usage and behavioral patterns overlaid on the cloud ecosystem, cloud posture management, misconfigurations compliance weaknesses and vulnerabilities. Enhanced features within the cloud security system may include i) prioritize on true cloud risk; ii) deep cloud network behavioral monitoring; iii) identity activity monitoring; iv) cloud autonomous response; and/or v) attack path discovery.

In general, in contrast to conventional cloud security software, the collecting of metadata associated with assets and communication paths to/from these assets, gathered through deep packet inspection or flow log monitoring, may provide additional information to more accurately model cloud-based components and environments to more accurately discern abnormal operability that may indicate cyber threats. The additional information may include data gathered through deep packet inspection and/or flow log monitoring, asset and/or policy configuration information, security policy information, role and/or access permissions. In general, enhanced risk assignment to best practices with a more robust granularity through the collected metadata.

Stated differently, the cloud security system is attempting to interconnect assets based on metadata and other information to assess which assets have high priority (based on cost and architecture construction). These costs may be imputed to assets in direct communication with the high priority assets. This identification of high priority assets is designed to identify devices that are to be avoided for being compromised as their expense dictates that they are interconnected within the architecture itself. The cloud security system can support both flow and API analysis through advance modeling by pulling various API metadata.

In accordance with another embodiment of the disclosure, the cloud security system may be configured to detect misconfigurations or failures to meet best practices in a cloud account for a selected user that is under analysis and collect information associated with misconfigurations/best practice failures on a per account basis and/or per logical structure (architecture). The collected information may identify a cyber threat incident. Through the cloud security system, the user is allowed to create a cloud remediation plan.

For creation of the cloud remediation plan, the user is able to select which cloud account or accounts (hereinafter, “cloud account(s)”) the user wishes to target. In general terms, the cloud accounts may be viewed as being equivalent to tenants in AWS. Upon selection of the targeted cloud account(s), one or more targeted architectures within those cloud account(s) and/or targeted misconfiguration groups can be selected. The misconfiguration groups may represent monitored activities or omissions, such as one or more incidents or a series of failures to meet best practices that would compromise the cloud security system. Lastly, types of alerts may be selected in which a user or subset of users to receive the alert(s) is provided along with one or more communication pathways (e.g., communication channels such as Teams/Slack channel) for this cloud remediation plan.

As a result, the cloud remediation plan would feature a listing of all the configurations, misrepresentations, and alerts that need to be handled along with the assignees that are identified receive the alerts. Additionally, cloud remediation plan may include an activity log of the actions that are done to resolve the alerts. A listing of features of a cloud remediation plan may include, but is not limited or restricted to the following: 1) table of configuration; 2) search and add assignees; (3) activity log; 4) campaign percent complete with assignee breakdown stat summary: X resolved, Y investigated; 5) hook activated as an cloud service module (e.g., AWS module) of the cyber security system to conducts analytics for events relating to any of the assets, the module adds the campaign ID into the resources field which allows us the UI to search for them for the activity log window; 6) ability to add a link to a ticket/tickets; 7) quick copy to copy all info across to a prescribed ticket system; 8) manual re-scan button can trigger the cyber security system to look for updates; and/or 9) daily/weekly update emails to campaign owner (+additional assignees) and to the Microsoft® Teams®/Slack® communications channel.

As a result, certain types of security attack campaigns may be tracked and remediated. The progress of the campaigns and handling of the campaigns may be determined by knowing which architectures have changed. This may be accomplished by pulling the activity log of the AWS module to provide information about the assets and any changes made to the assets, such as misconfiguration of settings, etc.

In the event there is no cloud trail log provided or enabled, the AWS module can be utilized to provide the user with actions made to fix a potential hole in the system. The ability to open tickets in an automated task management system (e.g., GitLab™, Jira™, etc.) may be used to scan the environment to see and construct misconfigurations made in the file that secure the products. Therefore, the cloud remediation plan is an extension to a cloud security system to provide a restoration (heal) preventative function to prevent misconfigurations and/or vulnerabilities from being compromised.

Additionally, the cloud security system may be configured with a cyber security restoration (e.g., self-healing) engine that invokes regular snapshots of virtual systems and use them to backup or restore different virtual systems of the AI-based cyber security system as part of a self-healing process. Cloud remediation through the self-healing process is an extension to cloud security in lieu of mediation that further allows or prevent functionality because it mitigates misconfigurations and failure to meet best practices.

More specifically, it would be advantageous to implement a cloud security system that identifies cloud assets, recovers metadata (e.g., data, properties, metrics, etc.) associated with these cloud assets, and constructs one or more cloud architectures (hereinafter, “cloud architecture(s)”) to represent related or grouped cloud assets, namely cloud assets that collectively or inter-dependently operate in accordance with the same or similar policies for a same specific function or purpose. Each cloud architecture may be rendered as a graphical representation of interconnected cloud assets to provide a holistic understanding of a cloud environment of an enterprise or customer (hereinafter, “customer cloud environment”) along with various levels of criticality as to alerts ranging from potential cyber threats directed to cloud assets along with IAM in the context of expected operations (e.g., pattern of life) to detect cloud asset misconfigurations. One example of a “misconfiguration” may involve a setting or configuration for that cloud asset that was not applied or applied incorrectly thereby creating a vulnerability that attackers can exploit or a non-compliance action that is against recommended or standard security practices.

According to an embodiment of the disclosure as described below, the cloud security system is configured to perform cloud asset enumeration, cloud asset discovery, metric collection, and cloud asset mapping to populate a data store with information (metadata) associated with cloud assets within a customer cloud environment. Thereafter, the cloud asset data store may be accessed to i) formulate and render customer-based cloud architectures, ii) determine potential cyber threats (e.g., suspicious network and identity activities, IAM misconfigurations, and/or other threat risk levels for the cloud assets and/or the cloud architectures), and iii) perform machine-learning based (ML-based) analytics in accordance with cloud-based “pattern of life” modeling that aggregates metadata associated with multiple ephemeral cloud assets operating with the same or similar policies for a specific function or purpose, such as virtual machines for example, to identify potential cyber threats associated with the cloud assets and/or cloud architectures and account for auto-scaling-automatically activating (spinning up) and discarding (spinning down) to account for varying workloads in the customer cloud environment.

As an illustrative example, the cloud security system may be configured with a cloud asset enumeration component, a cloud asset discovery component, an activity metrics collection component, an enrichment metric collection component, a risk assessment component, an architecture creation component, and/or an architecture rendering component. These components collectively operate to detect cloud assets, acquire metadata associated with the cloud assets, formulate cloud architectures based on interconnectivity between these cloud assets learned from metadata acquired via the cloud provider API(s) and/or installed sensor(s). In addition to the acquisition of the metadata associate with the cloud assets for cloud architecture formation, the cloud security system is configured to identify cyber threats and/or misconfigurations associated with the cloud assets based on a cloud-based pattern of life modelling analytics, determine cloud asset and/or architecture costs, and/or security risks for each cloud asset and cloud architecture.

The cloud security system may identify different cloud asset types, namely any logical or physical element that defines or determines access within a cloud network. For example, one cloud asset type may be directed to compute engines (e.g., AWS™ Elastic Compute Cloud “EC2”, Azure® virtual machines, Google® compute engine, etc.). Other cloud asset types may include, but are not limited or restricted to databases, compute services (e.g., AWS™ Lambda™, Azure® Functions, etc.), firewalls, user profiles, user policies, data stores (e.g., AWS™ Simple Storage Service “S3”, Azure® blob storage, etc.), virtual machines, or the like. In lieu of merely categorizing individual cloud assets, the cloud security system is further configured to contextualize these cloud assets by at least grouping related cloud assets and constructing them into interactive, customer-specific cloud architectures that reflect the relatedness and interconnectivity of these cloud assets operating within the customer cloud environment. This involves assessing cloud assets in the context of how these cloud assets cooperate as a cloud architecture for generating a cloud-based “pattern of life” for this and related cloud asset determination based on normal or expected operability of a cloud architecture that features the grouped cloud assets.

Cloud asset discovery, access mapping and posture management scanning combine to reinforce active detections over cloud networking and inconsistent IAM activity as well as the generation of alerts associated with such detections. By visualizing cloud architectures as interconnected cloud assets, the cloud security system combines behavior modelling with risk understanding to create a new paradigm of ‘pattern of life’ awareness.

With architecture discovery conducted by a cloud security analytics subsystem of the cloud security system as described below, risk and prioritize actions points can be tracked whilst automatically responding to threats on the network through the cloud assets. For instance, with respect to cloud asset discovery, the cloud security analytics subsystem discovers all cloud assets by enumeration. Initially on deployment, and on new asset creation, the cloud security analytics subsystem may be configured to conduct a scan across cloud accounts to inventory all cloud assets including, but not limited or restricted to instances such as compute engines or compute services, data stores, virtual machines, and other types of assets. The cloud security analytics subsystem then automatically assembles these assets into architectures; grouped collections of components that interact closely, representing connected systems and infrastructure in the cloud. This discovery and analysis are entirely automated.

For access mapping, as part of this architecture creation, the cloud security system (e.g., cloud asset enumeration component of the cloud security analytics subsystem) simulates AWS access restrictions for both IAM and certain cloud assets, mapping the routes that exist between the cloud assets, users, and roles. From this analysis, a network security team learns who and what assets can connect to each other, and determine one or more cloud-based pattern of life models, which the implications of these connections from a risk perspective and may be used in determination of cloud-based pattern of life modeling. These interconnected relationships in the cloud are visualized through one or more interactive graphic user interfaces (GUIs) to identifying effects of one cloud asset on another. With this analysis, attack path modelling from automated response modules (e.g., DARKTRACE® PREVENT™) can be extended to cloud infrastructure to enable a network security team to foresee likely data propagation paths to be exploited, and how malicious actors could move between cloud assets within the customer cloud environment.

The GUI may be configured to operate, in cooperations with the cloud asset enumeration component and the asset management component, to generate visualizations that identify model breaches as well as misconfigurations along with visual representations when alerts or misconfigurations occur by changing the color of the components shown on the user interface as well as likely attack paths through the cloud based network and architecture shown on the user interface in different colors. Moreover, the GUI may be configured to operate with the asset management component to i) list the misconfigurations detected in the cloud architecture of the network, 9ii) the level of severity of the misconfiguration, iii) highlight severe levels of misconfigurations past a certain threshold on the visual user interface with different colors, 9iv) how to fix the misconfiguration, and/or v) why that misconfiguration is a bad thing, all in the same visualization (e.g. screen display) based upon the data coming from the misconfiguration component and then scripts drafted for the user interface.

Herein, the logic of the cloud security system is configured to cooperate with i) a first set of Artificial Intelligence (AI) models trained and configured to model a pattern of life associated with a stable (or static) cloud environment and ii) a second set of AI models trained and configured to model a pattern of life for ephemeral cloud assets.

For risk insights, as cloud assets do not operate in isolation; the cloud security system prioritizes detection and response based on an understanding of the customer cloud environment. By intelligently grouping cloud assets into architecture representations, the cloud security system can model risk for both individual cloud assets and cloud architectures that feature grouped cloud assets. The modeled risk results combine multiple sources of risk from across the cloud security system platform-model breaches (network), misconfigurations, attack paths, knowledge of sensitive asset types and exposure-all these factors are brought together to build an understanding that loops back into the prioritization of all detections. The cloud security system can further track risk and prioritize actions points whilst automatically responding to cloud threats. Hence, the cloud security system curates the most relevant (prioritized) misconfigurations and unusual activity alerts for the network security team to review

As part of the complete cloud understanding, the cloud security system also detects and provides remediation operations for misconfigurations in cloud accounts and clusters. These misconfigurations are intelligently prioritized, based upon their overall contribution to risk across the customer cloud environment. For example, misconfigurations in close proximity to sensitive assets or higher cost components are highlighted over those in lesser cost (e.g., lesser used) components.

The cloud security system can provide network-level coverage over a cloud environment (e.g., Amazon Web Service (AWS) cloud environment) extending visibility and response into the virtualized parts of the cloud security system infrastructure. In areas where higher-level insights are desired, the cloud security system supports VPC flow log ingestion. For a low-level traffic analysis approach, deep packet inspection can be achieved with one or more virtual sensors. Three categories of sensor are available for enhancing cloud asset (and/or grouped cloud asset) monitoring to enable tracking at the metadata level: virtual probes (v-sensor), traffic-forwarding agents (os-sensor), and/or container sensors (c-sensor).

Anomaly detection is not limited to pattern of life analytics associated with network-based cloud assets. Rather, the cloud security system learns the pattern of life for cloud identities (user). Complemented by insights from access mapping, unusual behavior from an over-privileged user, or a user with access to sensitive assets, can be highlighted and prioritized. Hence, the cloud security system can detect anomalies across a variety of cloud-based interactions and events.

Lastly, the cloud security system is further configured to autonomously initiate and effectuate response and remediation steps, ensuring unusual activity is contained and potentially critical cyber threats against network-based cloud assets and cloud asset misconfigurations cannot be exploited.

With the addition of response and remediation operations through the autonomous response module, the cloud security system can take action to prevent a variety of cyber threats including blocking access to an S3 bucket, restricting network traffic to an EC2 instance, completely locking down an IAM credential, and more. Network-level threats can also be shut down by virtual sensors, wherever deployed.

These and other features of the design provided herein can be better understood with reference to the drawings, description, and claims, all of which form the disclosure of this patent application.

### BRIEF DESCRIPTION OF THE DRAWINGS

Embodiments of the invention are illustrated by way of example and not by way of limitation in the figures of the accompanying drawings, in which like references indicate similar items and in which:

FIG. 1A illustrates a block diagram of a first embodiment of a cloud security system deployed as part of a customer on-premises (“on-prem”) network to (a) autonomously interact with cloud network(s) to identify cloud assets and cloud architectures associated with a customer cloud environment and (b) interact with a cyber security appliance to perform analytics on the cloud assets and/or cloud architectures to identify potential cyber threats.

FIG. 1B illustrates a block diagram of a second embodiment of the cloud security system deployed as part of a customer on-prem network to (a) autonomously interact with cloud network(s) to identify cloud assets and cloud architectures associated with a customer cloud environment and (b) interact with a cloud-based cyber security appliance to perform analytics on the cloud assets and/or cloud architectures to identify potential cyber threats.

FIG. 1C illustrates a block diagram of a third embodiment of a cloud security system hosted as part of the cyber security appliance to (a) identify cloud assets and cloud architectures associated with a customer cloud environment and (b) perform analytics on the cloud assets and/or cloud architectures to identify potential cyber threats.

FIG. 2 illustrates a block diagram of the general interactions between the cloud security system of FIGS. 1A-1C and both source content providers and output systems.

FIG. 3 illustrates a block diagram of the cloud security system, operating as part of the on-prem network of FIGS. 1A-1B, to collect information from different sources to formulate a holistic understanding of enterprise security inclusive of security of the customer cloud environment.

FIG. 4 illustrates a block diagram of a cloud asset enumeration component of the cloud security system of FIG. 3 to identify cloud assets notably cloud components, enumerate metadata associated with the cloud components, identify cloud asset notably network cloud components, enumerate metadata associated with cloud components, and conducting mapping of the cloud assets.

FIG. 5 illustrates a block diagram of a cloud asset discovery component of the cloud security system of FIG. 3 to identify threat intelligence, presence of sensitive information, or vulnerabilities associated with the cloud and/or network assets.

FIG. 6 illustrates a block diagram of an activity metrics collection component of the cloud security system of FIG. 3 to identify activity-based assets such as network logs, audit logs, and/or network data.

FIG. 7 illustrates a block diagram of an asset management component of the cloud security system of FIG. 3 to determine cost estimates and/or setting misconfiguration associated with the cloud and/or network assets.

FIG. 8 illustrates a block diagram of a risk assessment component of the cloud security system of FIG. 3 to determine risk levels associated with a cloud asset and/or cloud architectures.

FIG. 9 illustrates a block diagram of an embodiment of the AI-based cyber security appliance of FIGS. 1A-1B.

FIG. 10 illustrates a block diagram of an architecture creation component and an architecture rendering component of the cloud security system of FIG. 3 to generate and render visualizations of the customer cloud environment associated with the customer.

FIG. 11 illustrates exemplary embodiment of a first display layout representing a cloud security interface generated by a graphic user interface (GUI) operating in concert with the architecture rendering component of FIG. 10 to identify different cloud assets.

FIG. 12 illustrates an exemplary embodiment of a second display layout representing cloud assets, links and/or architectures of the customer cloud environment in response to activation of a display element within the first navigation.

FIG. 13A illustrates an exemplary embodiment of a third display layout representing providing illustrations of the cloud asset architectures.

FIG. 13B illustrates an exemplary embodiment of a fourth display layout representing more detailed illustrations of alerts associated with one of the cloud asset architectures (i.e., production payment system cloud architecture) of FIG. 13A.

FIG. 13C illustrates an exemplary embodiment of a fifth display layout representing more detailed illustrations of assets associated with one of the cloud asset architectures (i.e., production payment system cloud architecture) of FIG. 13A.

FIG. 13D illustrates an exemplary embodiment of a first secondary display layout (sub-diagram) representing detailed of a display element generated from selection of a cloud asset of FIG. 13C.

FIG. 13E illustrates an exemplary embodiment of a second secondary display layout (sub-diagram) representing more detailed illustrations of permissions associated with one of the cloud asset architectures of FIG. 13A.

FIG. 13F illustrates an exemplary embodiment of a third secondary display layout (sub-diagram) representing more detailed illustrations of cloud asset access for one of the cloud asset architectures of FIG. 13A.

FIG. 14 illustrates an exemplary embodiment of a sixth display layout representing more detailed illustrations of cloud alerts associated with the customer cloud environment of FIG. 11.

FIG. 15 illustrates an exemplary embodiment of a seventh display layout representing more detailed illustrations of misconfiguration alerts associated with the cloud alerts of FIG. 14.

FIG. 16 illustrates an exemplary embodiment of an eighth display layout representing more detailed illustrations of network and IAM alerts associated with the cloud alerts of FIG. 14.

FIG. 17 illustrates a block diagram identifying logical operations performed in creating a cloud remediation plan based on operations performed by the cloud remediation planning component of FIG. 3.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that one or more embodiments of the disclosure can be practiced without these specific details. In other instances, well-known components or methods have not been described in detail but rather in a block diagram in order to avoid unnecessarily obscuring the present design. Further, specific numeric references, such as a first computing device for example, have been made. However, the specific numeric reference should not be interpreted as a literal sequential order but rather interpreted that the first computing device may be different from a second computing device.

As set forth herein, the specific details are merely exemplary and for illustrative purposes. Hence, the features implemented in one embodiment may be implemented in another embodiment where logically possible. The specific details can be varied from and still be contemplated to be within the spirit and scope of the present system or component configuration.

### I. Terminology

In the following description, certain terminology is used to describe various features of the invention. For example, the terms “component,” “module” and “logic” are structures that can be implemented with electronic circuits, software stored in a memory executed by one or more processors, and/or a combination of both. For instance, the component (or module or logic) may be representative of hardware, firmware or software that is configured to perform one or more functions. As hardware, a component (or module or logic) may include physical circuitry having data processing or storage functionality. Examples of such circuitry may include, but are not limited or restricted to a hardware processor (e.g., microprocessor with one or more processor cores, a digital signal processor, a graphics processing unit (GPU), a programmable gate array, a microcontroller, an application specific integrated circuit “ASIC,” etc.), a semiconductor memory, or digital or analog hardware.

Alternatively, the component (or module or logic) may be software that includes code being one or more instructions, commands, or another data structure that, when compiled and/or processed (e.g., executed), perform a particular operation or a series of operations. Examples of software may include an application, a process, an instance, an Application Programming Interface (API), a routine, a subroutine, a plug-in, a function, an applet, a servlet, code, a script, a shared library/dynamic link library (dll), logical circuitry (e.g., logical functionality of the physical circuitry descried above), or one or more instructions. This software may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; non-persistent storage such as volatile memory (e.g., any type of random-access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the component (or module or logic) may be stored in persistent storage.

In general, the term “asset” generally relates to any logical or physical component that performs a specific task or function, such as managing security of a logical or physical network. For instance, a “cloud asset” relates to one or more logical component that performs a specific task or function within a cloud network, and thus, a cloud asset may be directed to a single cloud asset or a group of cloud assets (grouped cloud assets) to be analyzed as a collective unit. Examples of cloud assets may include, but are not limited or restricted to ephemeral, cloud-based components or services such as compute engines (e.g., AWS™ EC2, Azure® Azure® virtual machines, Google® compute engine, etc.), logical data stores (e.g., AWS™ S3, Azure® blob storage, etc.), policies, roles, users, certificates, virtual machines, network-based assets such as virtual private clouds (VPCs) or subnets, edges (communication paths between two logical components), or the like (herein, “ephemeral cloud assets”).

The term “content” generally relates to a collection of information, whether in transit (e.g., over a network) or at rest (e.g., stored), often having a logical structure or organization that enables it to be classified for cloud architecture formation and cyber-threat detection and prevention.

Herein, the term “element” relates to a visual representation of content. For example, in some cases, the term “display element” relates to a broader visual representation of content (e.g., web page, window, etc.) and the term “graphical element” relates to a more specific visual representation of content such as one or more objects. The graphical element may be interactive, where the graphical element may be a node within the visualization or a graphical filtering element that, upon selection, cause the rendering of additional (display or graphical) elements.

The term “computing device” should be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of a computing may include, but are not limited or restricted to, the following: a server, a mainframe, a firewall, a router; or an endpoint device (e.g., a laptop, a smartphone, a tablet, a desktop computer, a netbook, gaming console, a wearable, etc.), or the like. The term “computing device(s)” denotes one or more computing devices.

The term “interconnect” may be construed as a physical or logical communication path between two or more electronic devices or between different logic (engine or components). For instance, a physical communication path may include wired or wireless transmission mediums. Examples of wired transmission mediums and wireless transmission mediums may include electrical wiring, optical fiber, cable, bus trace, a radio unit that supports radio frequency (RF) signaling, or any other wired/wireless signal transfer mechanism. A logical communication path may include any mechanism that allows for the exchange of content between different logic.

The term “message” generally refers to signaling (wired or wireless) as either information placed in a prescribed format and transmitted in accordance with a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE; Instant Message Access Protocol (IMAP); or the like. Hence, each message may be in the form of one or more packets, frame, or any other series of bits having the prescribed, structured format. The term “computerized” generally represents that any corresponding operations are conducted by hardware in combination with software or firmware.

The character set “(s)” denotes one or more items. For example, the term “network(s)” denotes one or more networks. The term “asset(s)” denotes one or more assets. The term “cloud architecture(s)” denotes one or more cloud architectures, and the like.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of components, logic, functions, steps, or acts are in some way inherently mutually exclusive.

### II. General Architecture

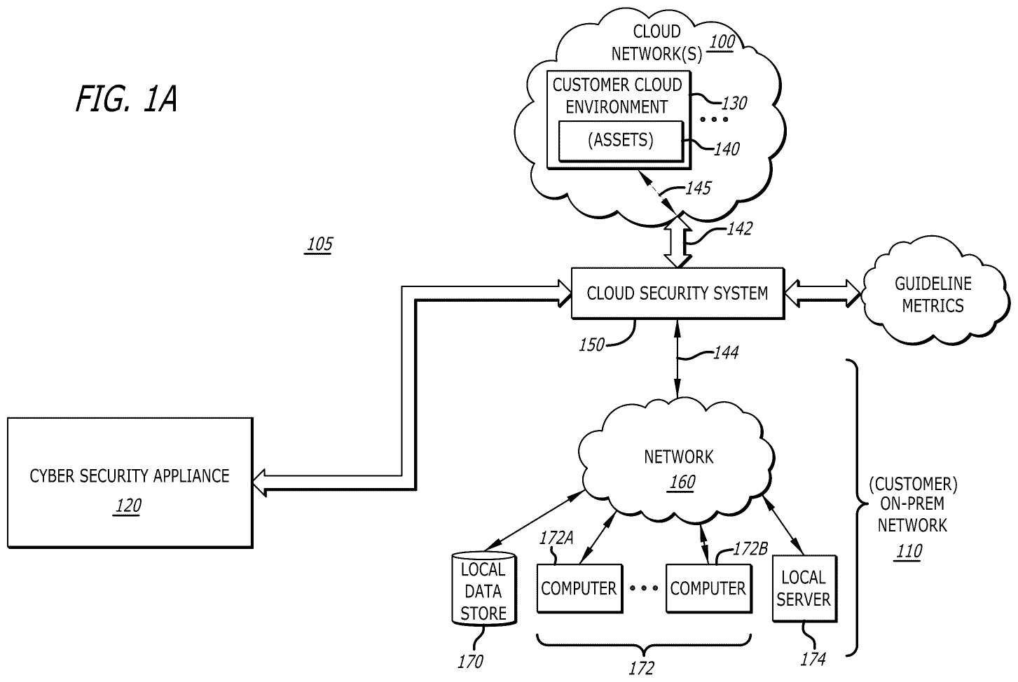

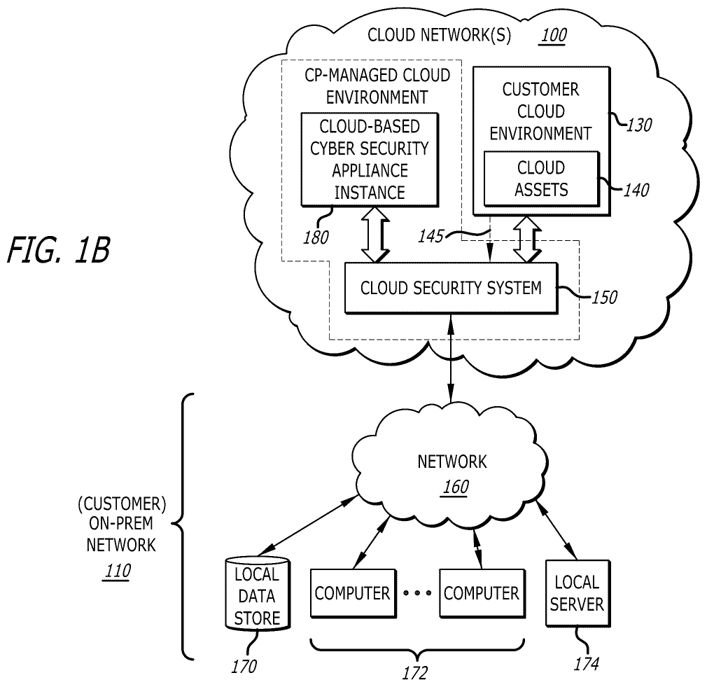

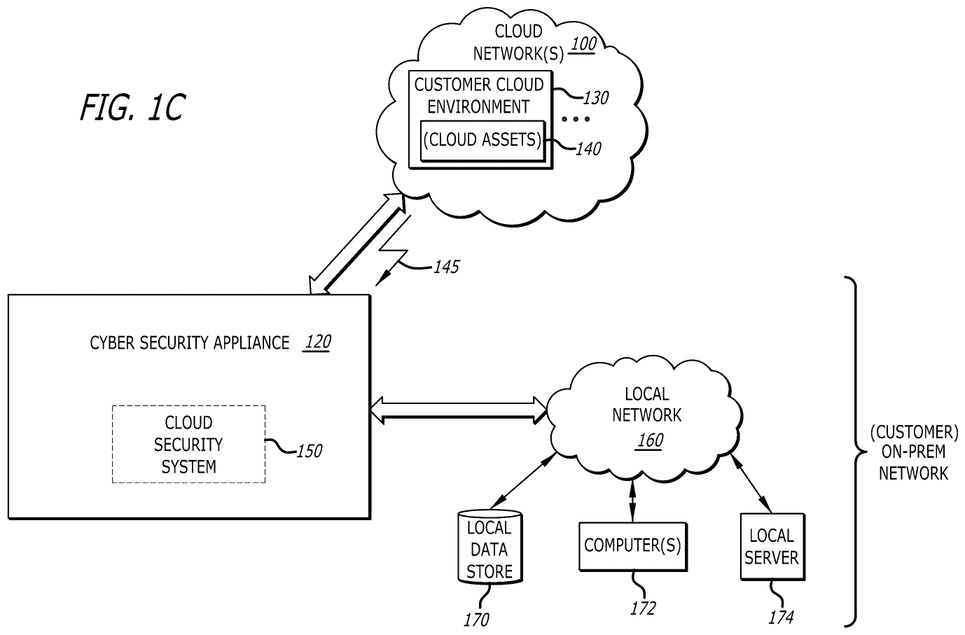

Referring to FIG. 1A, a block diagram of a first embodiment of a cloud security system 150 deployed as part of a customer's on-premises (on-prem) network 110 is shown. In particular, the cloud security system 150 may be deployed as an on-prem appliance, which is pre-configured to communicate with one or more cloud networks 100 (hereinafter, “cloud network(s)” 100) and an AI-based cyber security appliance 120. The cyber security appliance 120 and the cloud security system 150 collectively operate as a security system 105 for an enterprise (hereinafter, “enterprise security system”).

More specifically, as shown in FIG. 1A, the cloud security system 150 is configured to autonomously interact with a cloud environment 130 associated with a customer (hereinafter, “customer cloud environment 130”) maintained with the cloud network(s) 100 via interconnect 142. Herein, the cloud security system 150 is configured to identify cloud assets 140 within the customer cloud environment 130 and access metadata 145 associated with the cloud assets 140. The cloud assets 140 may include cloud-based components, services, and/or access controls (e.g., roles, policies including permissions, profiles, etc.) associated with the customer cloud environment 130, which are maintained within the cloud network(s) 100 operating as a part of a public cloud network. Alternatively, the cloud network(s) 100 may operate as one or more private cloud networks accessible to the customer.

Additionally, the cloud security system 150 is configured to identify the cloud assets 140 and cloud architectures assembled with a portion (subset) of the cloud assets 140 and provide a visualization these cloud assets forming some or all of the customer cloud environment 130. Furthermore, the cloud security system 150 is configured to perform analytics on both the cloud assets 140 and the cloud architectures to identify misconfigurations and cyber threat risks thereof. The metadata 145 associated with the cloud assets 140 and/or cloud architecture(s) along with the misconfiguration and risk findings may be used by the cyber security appliance 120 to identify potential cyber threats for the cloud architecture(s) and/or the individual cloud assets 140.

As further shown in FIG. 1A, the on-prem network 110 features a local network 160 that enables communications between a number of computing devices such as a local data store 170, one or more computers 172, and/or a local server 174. Consequently, all of the computers 172 are able to access the local server 174 and content within the local data store 170. According to this embodiment of the disclosure, the cloud security system 150 is coupled to both the local network 160 and to the cloud network(s) 100 via interconnects 142 and 144.

The cyber security appliance 120 may be a component residing outside the on-prem network 110 as shown or may be implemented as part of any or all of the computers 172. As this illustrative example, where functionality of the cyber security appliance 120 is deployed within a first computer 172a, including electronic hardware, modules, models, and/or various software processes of the cyber security appliance 120, the first computer 172a runs threat detection for detecting cyber threats pertaining to the customer cloud environment 130. As such, the first computer 172a includes one or more processors arranged to run the steps of the process described herein, memory storage components required to store information related to the running of the process, as well as network interfaces for collecting and acquiring information from the cloud security system 150 and/or any probes or other sensors collecting data from the network under analysis.

Referring still to FIG. 1A, the cyber security appliance 120 is configured to build and maintain dynamic, ever-changing models of the “normal behavior” of each user and computer within the enterprise security system 105 as well as multiple, related cloud assets and/or architectures utilized by a customer deploying the enterprise security system 105. This approach may be based on Bayesian mathematics, and monitors all interactions, events, and communications within both the system (e.g., which computer is talking to which, files are being created, networks are being accessed or the like) and the customer cloud environment 130 (e.g., customer cloud assets and/or cloud architecture(s) identified, metadata associated with the cloud assets and/or cloud architecture(s) collected, asset intercommunications determined, cost metrics for cloud assets and/or cloud architecture(s) collected and determined, cyberthreat risk for cloud assets, cloud architecture(s) and/or asset misconfigurations is determined, etc.).

For example, computer 172b or one of the cloud assets 140 may be based in the West Coast and is operated by a marketing employee who regularly accesses the marketing network, usually communicates with physical (computer 172a) or logical (cloud asset 140) devices between 9:30 a.m. and midday, and is active from around 8:30 a.m. until 6 μm. The same employee virtually never accesses the employee timesheets, rarely connects to the company's VLAN network as represented by local server 174, and has no dealings with Southeast Asia. The cyber security appliance 120 takes all the information that is available relating to the employee and establishes “pattern of life” models (AI models) for that person, for the physical and/or logical devices used by that person in that system which is dynamically updated as more information is gathered, and collection of ephemeral cloud assets operating in concert.

The AI modeling of the normal pattern of life for an entity (e.g., person, asset, etc.) in a network under analysis is used as a moving benchmark, allowing the cyber security appliance 120 to spot behavior on with the enterprise security system 105, including the customer cloud environment 130 monitored by the cyber security system 150, that seems to fall outside of the normal pattern of life and flags this behavior as anomalous, requiring further investigation and/or autonomous action. These operations are based on activity by the user as the cyber security appliance 120 takes into account the activities as described above as well as the risks associated with the customer cloud environment 130, which are provided by the cloud security system 150 and based, at least in part, on misconfigurations, vulnerabilities, the presence of sensitive data within publicly accessible cloud assets, or the like.

Referring now to FIG. 1B, a block diagram of a second embodiment of the cloud security system 150 deployed as part of the customer's on-prem network 110 is shown. Herein, the cloud security system 150 is configured to autonomously identify cloud assets 140 within the customer cloud environment 130 and access metadata associated with the cloud assets 140. Differing from FIG. 1A, as shown in FIG. 1B, the cyber security appliance may be deployed as an instance 180 within the cloud network(s) 100 accessible by the customer (e.g., cloud provider managed cloud environment). Herein, the cloud security system 150 is adapted to interact with the customer cloud environment 130 in order to enumerate the cloud assets 140, conduct cloud asset discovery in order to assess threats, vulnerabilities, and sensitive stored information, determine enriched metrics and activity metrics to populate a data store including the metadata 145 associated with the cloud assets 140.

From these cloud assets 140, the cloud security system 150 may be able to generate cloud architectures and render these cloud architectures for visual display by the administrator. The cloud security system 150 is further configured to conduct risk assessments as to the threat levels associated with particular cloud assets as well as the cloud architecture(s) formed by some or all of these cloud assets 140. Herein, the cloud security system 150 is further configured to interact with the cloud-based cyber security appliance instance 180 in order to assess risks through normal “pattern of life’ modeling as well as ‘cloud-based” pattern-of-life modeling, where the modeling is directed to normal or expected behaviors for a grouping of cloud assets that may be ephemeral.

Referring to FIG. 1C, a block diagram of a third embodiment of the cloud security system 150 is shown. Herein, the cloud security system 150 is hosted by the cyber security appliance 120 to assess information associated with cloud assets 140 for the customer cloud environment 130 and to perform analytics on the information to determine whether any cloud architectures pertaining to the customer cloud environment 130 feature cyber threats. This may be accomplished by the cloud security system 150 having access to the customer cloud environment 130 enumerating the cloud assets 140, gather metadata 145 associated with the cloud assets 140 (including metadata about the assets and/or the relationships these assets have with each other) in order to generate the cloud architecture(s) pertaining to these cloud assets 140. Thereafter, the cloud architecture(s) can be visibly displayed along with risk levels identifying the potential threat of a cyberattack in connection with a particular cloud asset and/or the entire cloud architecture and measures, both manual and automated, may be undertaken to address misconfigurations and activities that caused network and identify (NI) alerts.

### III. Cloud Security System

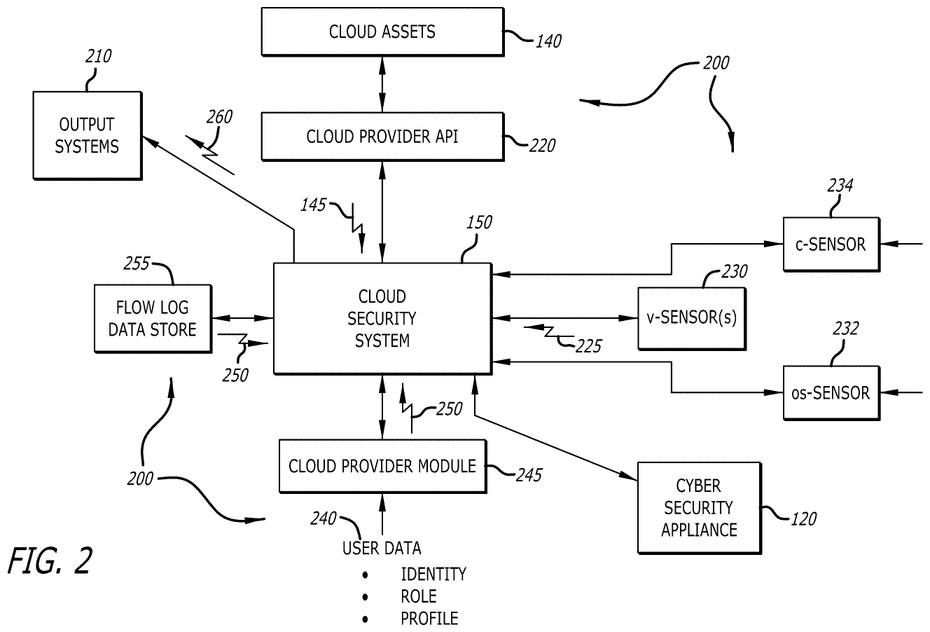

Referring to FIG. 2, a block diagram of the general interactions between the cloud security system 150 as well as a plurality of content providers 200 and output systems 210 is shown. Herein, as described above and illustrated in FIG. 1A, the cloud security system 150 is configured for ingest data from different sources, including the metadata 145 associated with the cloud assets 140 of the customer cloud network(s) 100 as obtained via a cloud provider API 220, network traffic data 225 from v-sensors 230, host-based information (e.g., OS-type, etc.) provided from hosted agents, internal state of cloud-based applications via the c-sensors 234, user data 240 (e.g., user profiles, user role information, user profiles, etc.) via a cloud provider module 245 (e.g., AWS™ module), and/or log data 250 (e.g., flow logs and/or audit logs to track identity-based behaviors maintained in a flow log data store 255).

This may involve the use V-sensors, which are configured to receive network data through traffic mirroring, host-based sensors such as OS-sensors, and/or container (Kubernetes) sensors.

In particular, the cloud security system 150 is configured with components to perform a number of operations on the ingested data. Some of these operations may include, but are not limited or restricted to the following: cloud asset enumeration, access mapping for access/network path determination, cloud security posture management (CSPM) directed to compliance and misconfiguration detection, Kubernetes Security Posture Management (KSPM) directed to compliance with Kubernetes environments, cost analytics, risk modeling, and/or cloud architecture generation and rendering.

As shown in FIG. 2, the cloud security system 150 is communicatively coupled to the output systems 210. More specifically, after conducting operations on the ingested data, the cloud security system 150 may be configured to provide one or more messages 260 to the output systems 210, where the messages 260 may constitute notifications, display message signaling (e.g., SLACK® messages, chat messages over a video-conferencing platform, graphical signaling for rendering cloud architecture representations, etc.), or even a “support” or “help” message (e.g., GitLab™ or service-related ticket). Additionally, or in the alternative, although not shown, the cloud security system 150 may further be coupled to the cyber security appliance 120 to leverage the AI modeling, autonomous response, and other modules in order to identify and tackle potential cyber threats.

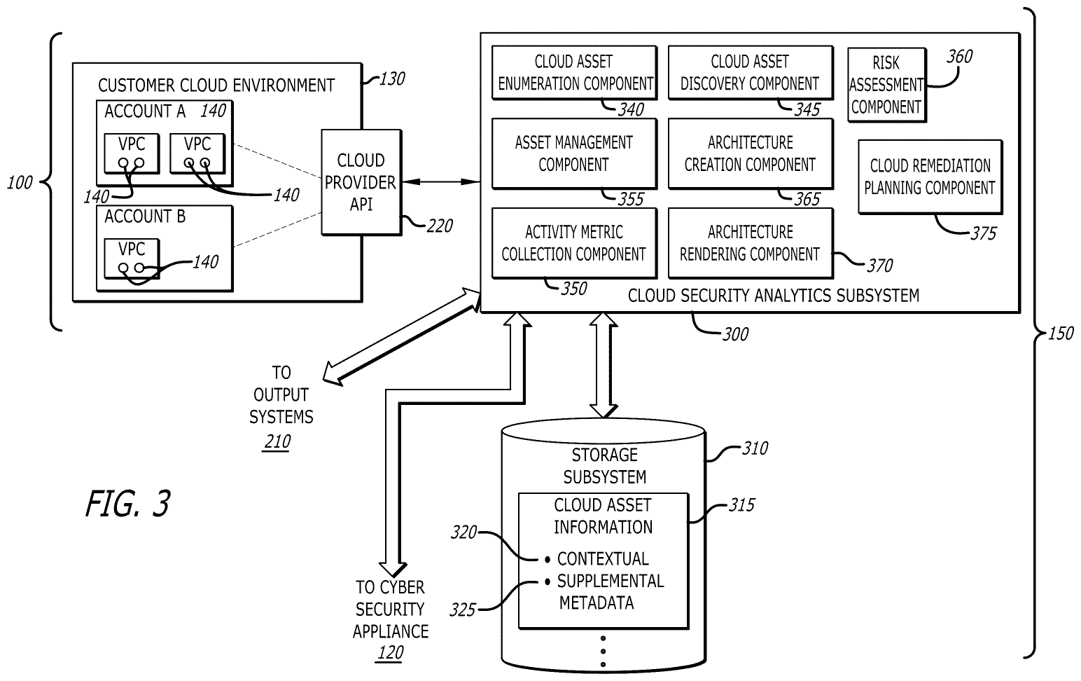

Referring now to FIG. 3, a block diagram of an exemplary embodiment of the cloud security system 150 is shown, where the cloud security system 150 may be configured to operate as part of the on-prem network of FIGS. 1A-1B. The cloud security system 150 is configured to, among other things, identify cloud assets, populate a local storage subsystem 310 with cloud asset information 315, which may be used to generate cloud architectures for visualization and metadata associated with the cloud assets 140 being utilized to conduct pattern of life analytics to determine potential cyber threats such as suspicious network and identify (NI) activity and/or misconfigurations that may increase susceptibility to threat actors. Herein, the cloud security system 150 features a cloud security analytics subsystem 300 and a storage subsystem 310. The storage subsystem 310 may be configured as one or more local data stores to maintain information associated with the cloud assets 140 detected by the cloud security analytics subsystem 300.

As an illustrative example, the storage subsystem 310 may include a first data store to maintain i) contextual information 320 (e.g., asset name, identifier within the cloud service (customer cloud environment), cloud account identifier, cloud asset type, location, service type (e.g., EC2, Lambda, etc.) along with ii) supplemental metadata 325 such as with asset properties (e.g., threat intelligence, presence of sensitive information such as financials or private personal information of employees, and known vulnerabilities pertaining to that cloud asset) and enriched metadata (e.g., activity metrics, cost metrics, misconfiguration metrics, etc.). Collectively, the contextual information 320 and supplemental metadata 325 associated with the cloud assets 140 provide a holistic view of the totality of the cloud assets as well as their context.

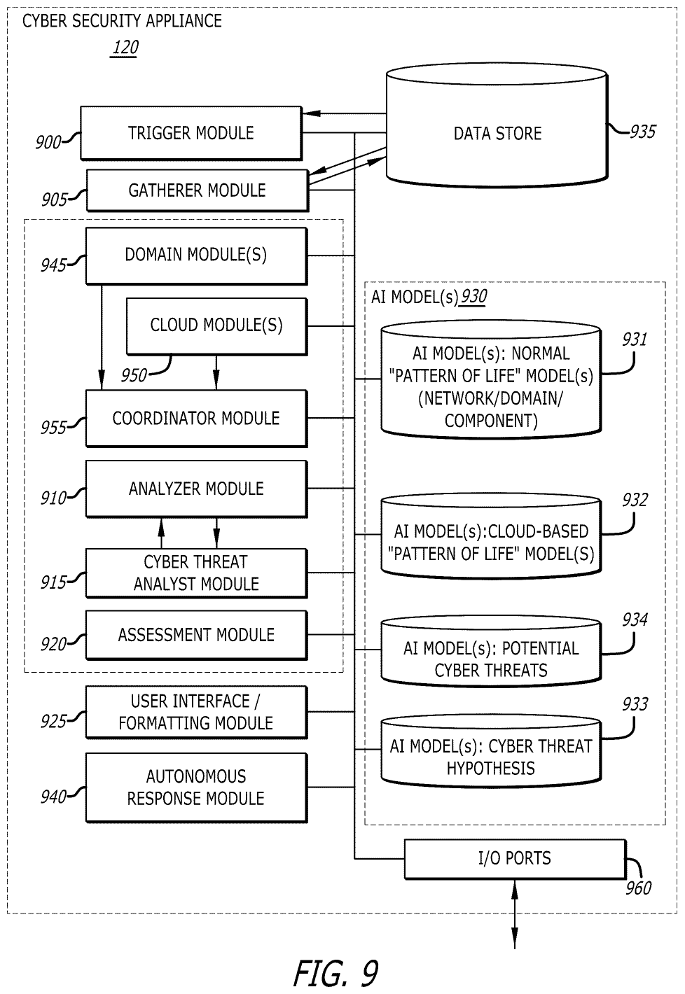

According to one embodiment of the disclosure, the cloud security analytics subsystem 300 is communicatively coupled to the customer cloud environment 130 accessible via a cloud provider API 220 to access and identify the cloud assets 140 as well as to collect the supplemental metadata 325 associated with the cloud assets 140. The cloud security analytics subsystem 300 is further coupled to output systems 210 to provide messages as notifications, chat messages, or tickets to request activity by a particular service provider. The cloud security analytics subsystem 300 may further be coupled to the cyber security appliance 120 to utilize AI modeling as shown in FIG. 9 (e.g., normal pattern-of-life modeling, cloud-based pattern of life modeling, etc.), autonomous response, and other modules in order to identify and tackle potential cybersecurity threats.

According to this embodiment of the disclosure, the cloud security analytics subsystem 300 features a cloud asset enumeration component 340, a cloud asset discovery component 345, an activity metric collection component 350, an asset management component 355, a risk assessment component 360, an architecture creation component 365, architecture rendering component 370, and/or a cloud remediation planning component 375. These components 340-375 may be configured to operate concurrently in which cloud architectures are generated based on information associated with the cloud assets uncovered by the cloud asset enumeration component 340.

As shown in FIG. 3, according to one embodiment of the disclosure, the cloud asset enumeration component 340 is configured to identify cloud assets, namely locate the cloud assets 140 that exist within the customer cloud environment 130. These cloud assets 140 may include any logical component (represented as a logical element) that performs a specific task or function within a cloud network such as a compute engine (e.g., AWS™ EC2, Azure® Azure® virtual machines, Google® compute engine, etc.), a logical data store (e.g., AWS™ S3, Azure® blob storage, etc.), policy, user role (e.g., for permission/privilege insight for asset accessibility), ephemeral components within a virtual private cloud (VPC), user profile (for identity monitoring), certificate (for user authentication and access controls), or the like. Metadata associated with each of the identified cloud assets is collected, categorized, and provided to the storage subsystem 310.

According to this embodiment, the cloud asset enumeration component 340 may be further configured to conduct access mapping operations by determining what cloud assets have access to other assets for subsequent formation and rendering of the architectures. This analysis may involve an evaluation of the cloud asset metadata, where the evaluation may be conducted by search logic to identify communications paths between cloud assets (hereinafter, “access paths”). Additionally, the cloud asset enumeration component 340 may be configured to conduct network mapping operations by performing analytics of the network-based cloud assets (e.g., VPCs, subnets, etc.) as well as the network policies to determine communication paths for these network-based cloud assets (hereinafter, “network paths”) to determine related cloud assets. One or more cloud-based “pattern of life” models may be created based on the enumerated cloud assets.

According to one embodiment of the disclosure, as further shown in FIG. 3, the cloud asset discovery component 345 is configured to identify and collect asset property information from one or more queries to the cloud provider API 220. The asset property information may be directed toward threat intelligence, vulnerabilities, and sensitive information maintained within the cloud assets 140. This asset property information may be used by the risk assessment component 360 to determine risk levels associated with each cloud asset as well as cloud architectures-namely a set of connected cloud assets that are interconnected within the customer cloud environment 130 representing a discrete infrastructure or project.

The activity metric collection component 350 is configured to determine how cloud assets behave within the customer cloud environment 130. In particular, the activity metric collection component 350 may be configured to conduct analyses of log data and network traffic data in light of access controls (e.g., user privileges, user permissions, and/or policies). For example, the activity metric collection component 350 may perform identity monitoring by conducting analytics on audit logs to learn who or what is accessing the cloud assets 140. The activity metric collection component 350 may further perform enhanced identity monitoring by analyzing user roles to better understand privileges and insights into asset accessibility. Also, the activity metric collection component 350 may evaluate cloud asset behavior based on network traffic data received from v-sensor(s), os-sensor(s), and/or c-sensors (Kubernetes) in a cloud network. The metrics gathered from operations performed by the activity metric collection component 350 are added to metadata associated with pertinent cloud assets maintained within the storage subsystem 310.

The asset management component 355 is configured to perform cloud security posture management (CSPM) by at least conducting analytics on information associated with the cloud assets 140 in order to detect compliance and/or misconfiguration of these cloud assets, individually or as a group, within the customer cloud environment 130. The asset management component 355 is further configured to perform Kubernetes security posture management (KSPM) to determine compliance and/or misconfiguration within the Kubernetes environment. Additionally, the asset management component 355 may be configured to perform cost analytics as to costs associated with a particular cloud asset, a particular grouping of cloud assets, and/or a particular cloud architecture after generation by the architecture creation component 365.

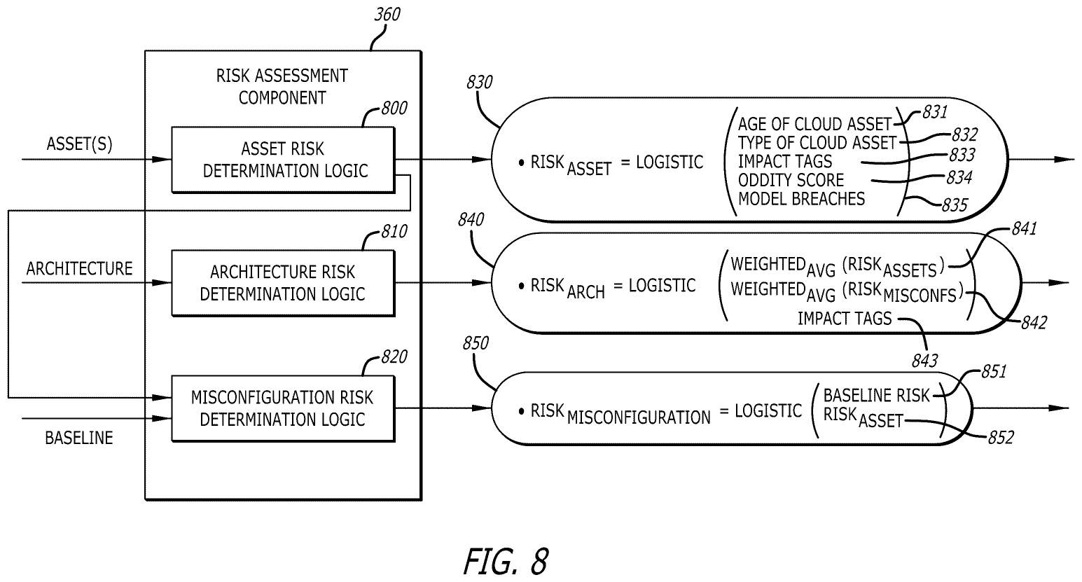

The risk assessment component 360 is configured to determine an estimated risk value (level) associated with each cloud asset (e.g., single cloud asset of grouped cloud assets), and/or determined cloud architectures. The cloud architecture risks may be based on weighted risk computations along with “impact tags,” namely a customer-controlled metric to heighten risk values assigned by the customer based on perceived importance (in operability) by the customer of certain cloud assets within the customer cloud environment 130. The risk assessment component 360 is able to compute an asset risk determination, an architecture risk determination, and a misconfiguration risk determination as illustrated in FIG. 8.

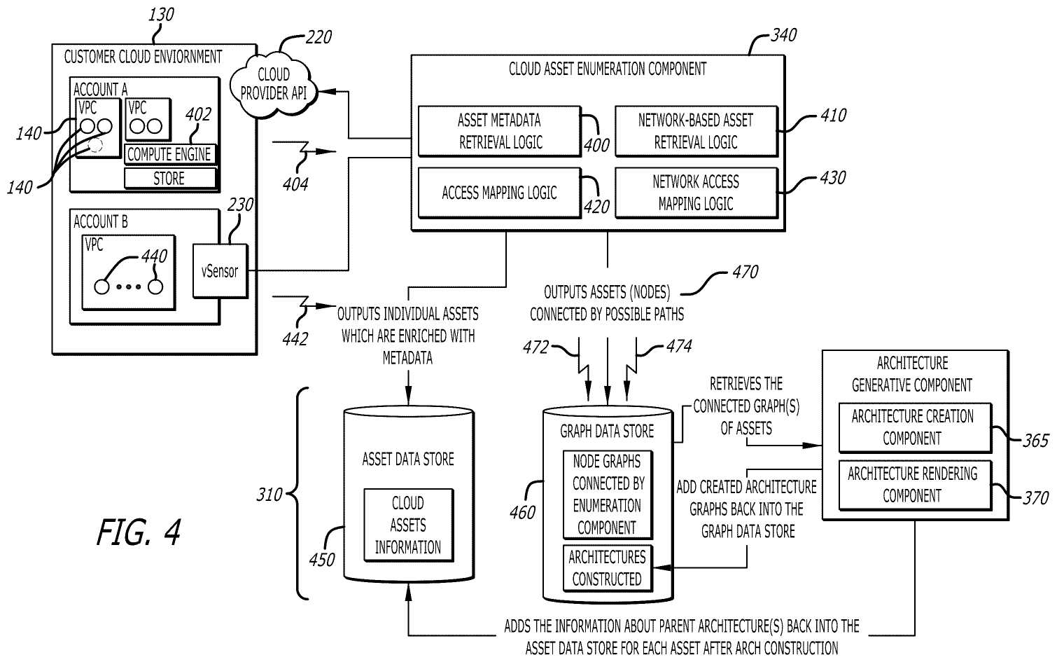

Lastly, the activity metric collection component 350 may be configured to conduct a third analysis (attack path mapping) to prioritize critical routes across the customer cloud environment 130. These paths are provided into a graphical data store within the storage subsystem 310 of FIG. 4.

Referring still to FIG. 3, the architecture creation component 365 is configured to determine cloud architecture (constructs) that represent a set (two or more) of the enumerated cloud assets in communication and associated with a unified purpose. The formation of the cloud architectures may be based on inter-asset relationships between the cloud assets 140 determined through access and network mappings as well as access controls. The architecture rendering component 370 is configured to generate graphical representations of the created cloud architectures as determined by the architecture creation component 365 where edge lines are used to represent relationship and communications between cloud assets represented as graphical nodes.

The cloud remediation planning component 375 is software configured to interact with a user interface generated by the cloud security system 150 and create a framework for more efficient remediation of potential misconfigurations and/or malicious network or identity activities through grouping of cloud assets (e.g., ephemeral components, accounts, etc.). In general, the cloud remediation planning component 375 detects misconfigurations or failures to meet best practices in a cloud account for a selected user that is under analysis and collect information associated with misconfigurations/best practice failures on a per account basis and/or per logical structure (architecture) basis in order to produce customer-specific cloud remediation plans.

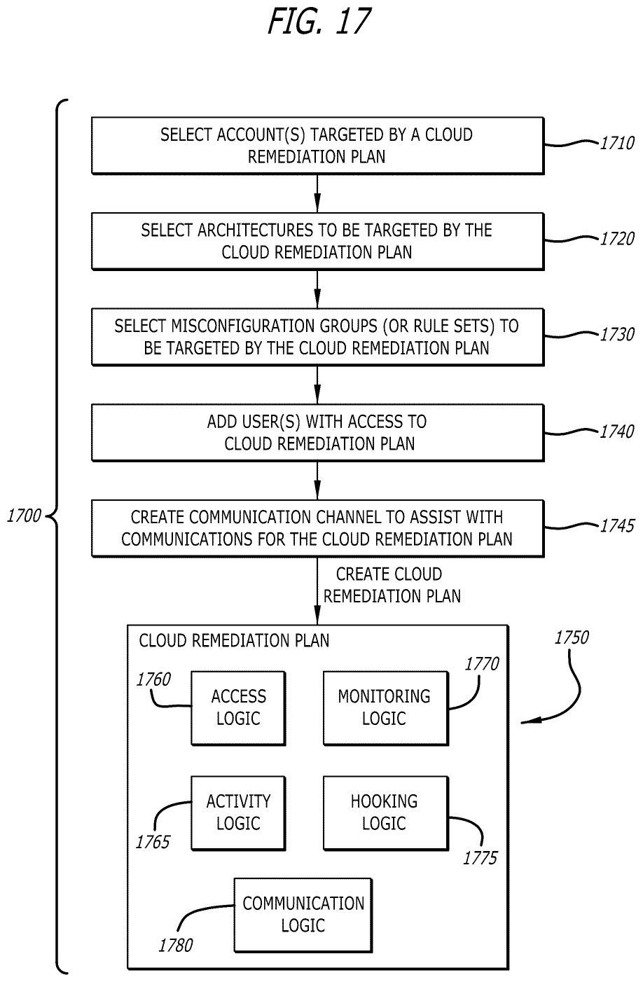

According to one embodiment of the disclosure, the cloud remediation planning component 375 supports a registration process to create a cloud remediation plan that categorizes alerts that may be handled to a single security team in lieu of categorization based on a selected basis (e.g., account basis, architecture basis, misconfiguration grouping basis, etc.). The software also supports an execution process in which the cloud remediation plan operates to organize alerts to be handled by a particular security team, as described below, and illustrated in FIGS. 17A-17B.

Referring to FIG. 4, a block diagram of a cloud asset enumeration component 340 of the cloud security system 150 of FIG. 3 to identify cloud assets, enumerate metadata associated with these cloud assets, identify network-based cloud assets, enumerate metadata associated with these network-based cloud assets, and conduct mapping of these cloud assets by leveraging metadata and other information to assist the architecture creation component 365 and/or the architecture rendering component 370 to aggregate cloud assets in the customer cloud environment (logical components, known communication patterns, asset/policy configuration, user interaction or IAM roles) and map out these cloud assets and their relational connections within the cloud architecture. This may be accomplished through asset metadata retrieval logic 400, network-based asset retrieval logic 410, access mapping logic 420, and network access mapping logic 430.

As shown, the asset metadata retrieval logic 400 may be configured to access the customer cloud environment 130 via the cloud provider API 220 in order to identify the cloud assets 140 associated with the customer cloud environment 130 and collect information (e.g., metadata) associated with each of the cloud assets 140. The cloud assets 140 may include any or all of the following: compute engines, logical data stores, policies, user roles, user profiles, digital certificates, or the like.

As an illustrative example, upon identifying a compute engine 402 as one of the cloud assets 140 utilized by the customer cloud environment 130, the asset metadata retrieval logic 400 collects information 404 associated with the compute engine 402. For a AWS™ cloud environment, the metadata associated with the compute engine 402 (e.g., EC2) may include, but is not limited to various contextual information such as the EC2 name (e.g., payment-controller), AWS identifier (ID) for the EC2, AWS account ID, cloud asset type (e.g., instance), region (e.g., US East (N. Virginia), service type (e.g., EC2), running status (e.g., running), operating system (OS) used (e.g., Linux/Unix), and the like.

The network-based asset retrieval logic 410 is configured to access the customer cloud environment 130 via the v-sensor 230 in order to identify network-based cloud assets 440, which are part of the cloud asset 140 of FIGS. 1A-1C. The network-based cloud asset 440 may include ephemeral cloud assets such as VPCs for example. The network-based asset retrieval logic 410 is further configured to collect information 442 (e.g., metadata) associated with each of the network-based cloud assets 440. Some of the metadata 442 associated with different network-based cloud assets 440 may differ based on their cloud asset type.

The information collected for the cloud assets identified by the asset metadata retrieval logic 400 and the network-based asset retrieval logic 410 (hereinafter, “cloud asset information”) is provided to an asset data store 450, which is part of the storage subsystem 310 of FIG. 3. This information is further enhanced with metadata collected from the access mapping logic 420 and network access mapping logic 430 as described below.

The access mapping logic 420 is configured to conduct analytics on the metadata associate with the cloud assets 140 to determine what cloud assets have access to other assets. The analytics may involve operations by search logic within the cyber security system 150 of FIGS. 1A-1C, starting at a selected cloud asset within the customer cloud architecture (e.g., compute engine, logical data store, etc.) and identifying other cloud assets that are communicatively coupled to the selected cloud asset. These operations may involve analytics on policies associated with the cloud assets to determine communicative relationships between them. These iterative operations are repeated for each of the other cloud assets to establish access paths between the cloud assets 140.

Similarly, for certain cloud assets, namely the network-based cloud assets 440 (e.g., VPCs, subnets, etc.), the network access mapping logic 430 may be configured to conduct network mapping operations by performing analytics of the network-based cloud assets 440 to determine the network paths for these network-based cloud assets.

Metadata associated with the access paths and network path is provided to the asset data store 450 as well as the graph data store 460. The graph data store 460 is part of the storage subsystem 310 of FIG. 3 and receives content 470 associated with assets to generate a nodal graph, namely the content associated with the cloud assets to be represented as nodes (hereinafter, “node content” 472) and content associated with the access paths and/or network paths to be represented as edges interconnecting the nodes (hereinafter, “path content” 474). More specifically, the graph data store 460 is communicatively coupled to the architecture creation component 365, and thus, is configured to provide the node content 470 and the path content 474 in response to a retrieval message from the architecture creation component 365.

Referring to FIGS. 3-4, the architecture creation component 365 is configured to determine cloud architectures (constructs) that represent a set (two or more) of the enumerated cloud assets in communication. The formation of the cloud architectures may be based on inter-asset relationships between the cloud assets determined through the access and network mappings, taking into account access controls (e.g., policies, permissions, privileges, etc.).

As these cloud architectures may overlap, the architecture rendering component 370 may be configured to perform architecture reduction by identifying overlapping cloud architectures and understanding the relationship between these overlapping cloud architectures. More specifically, the architecture reduction operations identify salient cloud assets that are shared by different cloud architectures. Thereafter, the similarity (compatibility) between these cloud architectures is determined based on relationships (e.g., policies, privileges and/or permissions) pertaining to the cloud architectures and/or cloud assets associated with these cloud architectures. If there is sufficient overlap in functionality (e.g., for AWS cloud environment—a first prescribed percentage, ≥10%, of EC2s are shared, a second prescribed percentage, ≥25%, of Lambda functions are shared, etc.) and the relationships do not warrant separation, the cloud architectures are merged to form a new cloud architecture. These reduction operations are iterative, until the cloud architectures have been evaluated and a subset of these cloud architectures are ready for rendering. The cloud-based pattern of life modeling may determine (group) ephemeral cloud assets may be performed in the same manner.

As an illustrative example, a first cloud architecture may feature three (3) Lambda functions while a second cloud architecture may feature four Lambda functions, inclusive of the three Lambda functions operating as part of the first cloud architecture. Hence, a pattern of life modeling associated with the first cloud architecture may be determined from analyzed behaviors of the three Lambda functions and/or any replacement Lambda functions. Where the fourth Lambda function would be compatible (and have little effect in the overall operability) with the first cloud architecture, these cloud architectures may be merged for render a cloud architecture featured as a combination of the first and second cloud architectures and a cloud-based pattern of life based on expected behaviors of the first-fourth Lambda functions. However, where the fourth Lambda function is incompatible with the first cloud architecture, such as the fourth Lambda function is communicatively coupled to thousands of other assets, these may constitute a significant distinction to keep the cloud architectures separate and multiple different cloud-based pattern of life models. Other compatibility determinations may be based on analytics associated with different metrics such as user roles, permissions, and conflicting policies.

The architecture rendering component 370 is further configured to generate graphical representations of the cloud architectures, where edge lines are used to represent relationship and communications between different cloud assets illustrated as nodes forming the cloud architecture.

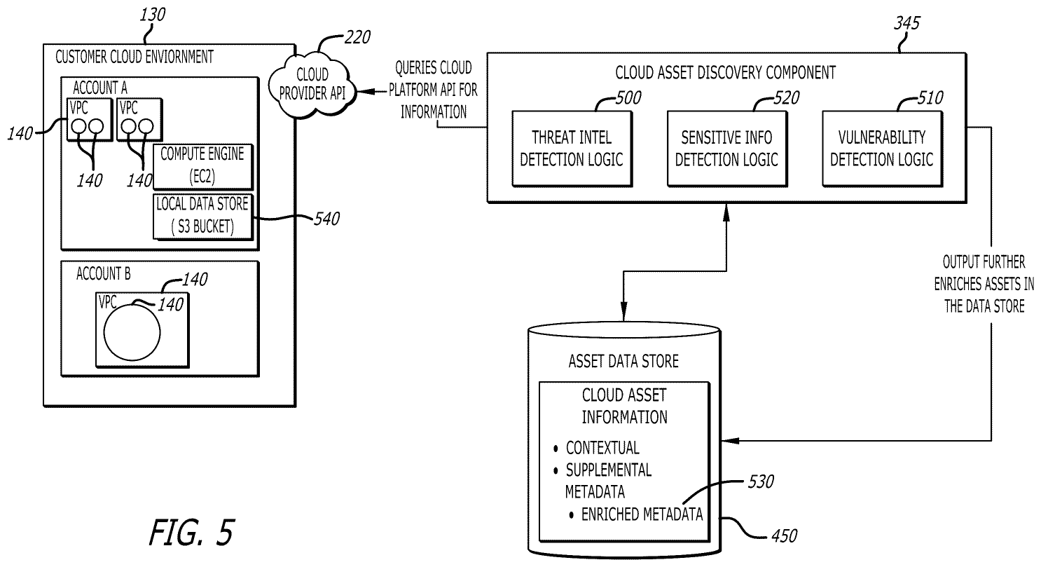

Referring now to FIG. 5, a block diagram of an exemplary embodiment of the cloud asset discovery component 345 of FIG. 3 is shown. Herein, the cloud asset discovery component 345 is configured to identify i) cloud provider threat intelligence available to the customer cloud environment 130, ii) sensitive information stored within the cloud assets 140, and/or iii) vulnerabilities associated with the cloud assets 140. The information associated with the threat intelligence, sensitive data storage, and/or vulnerabilities are provided as enriched metadata for the cloud assets to which this information pertains.

More specifically, the cloud asset discovery component 345 features threat intelligence detection logic 500, vulnerability detection logic 510, and sensitive information detection logic 520. The threat intelligence detection logic 500 may be configured to access cloud assets 140 within the customer cloud environment 130 via the cloud provider API 220 in order to collect existing threat intelligence maintained by the cloud provider. The threat intelligence may include information associated with advanced persistent threats (APTs) being monitored for or attempted on the customer cloud environment 130. For example, the threat intelligence detection logic 500 may be configured to collect cloud asset intelligence that identifies certain types of cloud assets within the customer cloud environment 130 that have been historically targeted for cyberattacks. This cloud asset intelligence (information) is collected and storage as enriched metadata 530 for content pertaining to the cloud asset that is stored within the asset data store 450.

The vulnerability detection logic 510 may be configured to access the cloud provider API 220 in order to in order to collect information pertaining to vulnerabilities associated with the cloud assets 140 and/or cloud architectures inclusive of the vulnerable cloud assets. For example, the vulnerability detection logic 510 may be configured to conduct analytics of metadata associated with the cloud assets 140 to determine potential vulnerabilities associated with one or more of these cloud assets 140, where the analytic results may be provided as part of the enriched metadata 530. For example, the vulnerability detection logic 510 may be configured to determine which of the cloud assets 140 are accessible to a public network or which of the cloud assets 140, if any, includes expired digitals certificates that may subject them to various cyber threats. Additionally, example, the vulnerability detection logic 510 may be configured to determine which of the cloud assets 140 include outdated security modules or a version of the operating system (OS) with certain known vulnerabilities.

The sensitive information detection logic 520 is configured to identify cloud assets operating as a logical data store within the customer cloud environment 130, such as AWS™ buckets 540 or other cloud provider logical data stores for example, which store sensitive information. The sensitive information may include password(s), confidential financial document(s), or other information that is deemed to cause damage to the enterprise if exposed. The presence of sensitive information within a particular cloud asset may be learned by the sensitive information detection logic 520 and provided as part of the enriched metadata 530 for that asset stored in the asset data store 450.

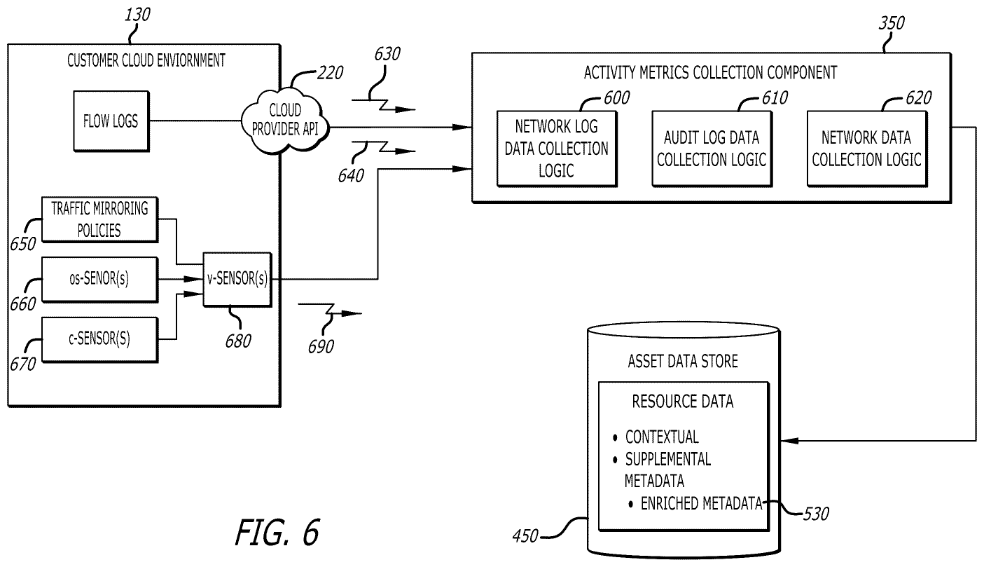

Referring now to FIG. 6, a block diagram of the activity metric collection component 350 of the cloud security analytics subsystem 300 of FIG. 3 is shown. In general, the activity metric collection component 350 is configured to determine how cloud assets behave within the customer cloud environment 130 based on collected log data and/or network data. According to one embodiment of the disclosure, the activity metric collection component 350 features i) network log data collection logic 600, ii) audit log data collection logic 610, and iii) network data collection logic 620.

The network log data collection logic 600 is configured to collect network addresses 630 (or domains) associated with cloud assets in communication with the customer cloud environment 130. For example, the network log data collection logic 600 may be configured to acquire Internet Protocol (IP) addresses associated with computing devices in communication with the network-based cloud asset such as a VPC.

The audit log data collection logic 610 is configured to access stored audit log data 640 that corresponds to data pertaining to users accessing any of the cloud assets 140 within the customer cloud environment 130. The audit log data 640 may include user profile metadata and/or user role metadata for example. The audit log data 640 is retrieved by the audit log data collection logic 610 and subsequently provided to the asset data store 450 as part of the enriched metadata 530 to populate the stored metadata pertaining to the accessed cloud asset to which the audit log data 640 pertains.

The network data collection logic 620 is configured to identify IP addresses associated with network traffic data monitored by traffic mirroring policies 650, os-sensor(s) 660 or c-sensor(s) 670, which are provided to a v-sensor(s) 680 positioned within the customer cloud environment 130. The network data collection logic 620 acquires metadata 690 associated with network traffic data via the v-sensor 680, where the metadata 690 is representative of cloud asset behavior based on the network traffic data. For example, from the acquired metadata 690, the network data collection logic 620 may identify that certain cloud assets are in communications with a specific domain (e.g., CompanyABC.com), which resides at a specific geographic region, communicates with the cloud asset at specific times of the day (per timestamp), and the like. The acquired metadata 690 associated with network traffic data may be collected by the network data collection logic 620 and provided to the asset data store 450 to be included as part of the enriched metadata 530 provide further context to understand the behavior of cloud assets and/or cloud architectures being the destination or source of the network traffic data.

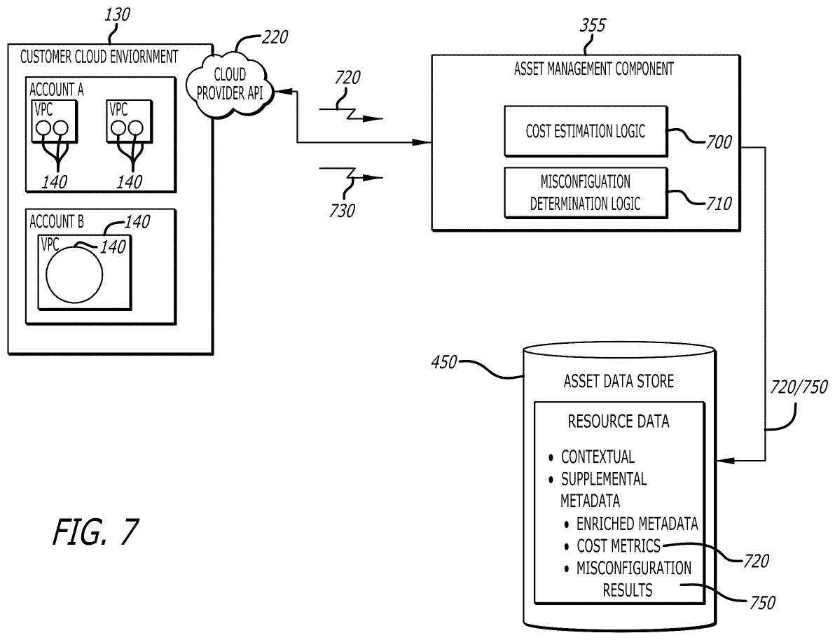

Referring now to FIG. 7, a block diagram of the asset management component 355 of the cloud security analytics subsystem 300 of FIG. 3 is shown. The asset management component 355 is configured to perform cloud security posture management (CSPM) by at least conducting analytics on information associated with the cloud assets 140 within the customer cloud environment 130 and/or the cloud architectures each associated with a set of these cloud assets 140 in order to detect compliance and/or misconfiguration of these cloud assets. Additionally, the asset management component 355 may be configured to i) perform Kubernetes security posture management (KSPM) to determine compliance and/or misconfiguration within a Kubernetes cluster within the customer cloud environment 130 and ii) cost analytics associated with a particular cloud asset and/or a particular cloud architecture after generation by the architecture creation component 365.

Herein, according to one embodiment of the disclosure, the asset management component 355 features cost estimation logic 700 and misconfiguration determination logic 710 that performs CSPM and/or KSPM operations. The cost estimation logic 700 may be configured to access the cloud provider resources via the cloud provider API 220 in order to acquire cost metrics associated with the cloud assets 140 that are maintained within the customer cloud environment 130. Examples of the cost metrics may include, but is not limited or restricted to costs associated with usage of compute engines, logical data stores or other resources that are monetized by the cloud provider.

Based on these acquired cost metrics 720, the cost estimation logic 700 may be able to identify and potentially rank those cloud assets and/or cloud architectures (determined by a summation of the set of cloud asset costs) that are more costly to deploy than others. This enables network administrators to identify costs, on a cloud architecture granularity, to allow the network administrators to understand the overall costs associated with the customer cloud environment 130 and initiate effective cost-cutting measures as needed. The cost metrics 720 may be assigned to the cloud assets and/or cloud architectures and provided to the asset data store 450 for storage.

The misconfiguration determination logic 710 is configured to assess properties associated with cloud asset 140 (i.e., each cloud asset or grouped cloud assets) to determine whether any of these properties have been incorrectly set. Herein, according to one embodiment of the disclosure, a misconfiguration for a first cloud asset may be identified by the misconfiguration determination logic 710 acquiring parameters 730 associated with the properties of the first cloud asset and comparing the acquired parameters 730 to a set of known misconfiguration parameters for that cloud asset type. According to another embodiment of the disclosure, a misconfiguration for a first cloud asset, such as a group (two or more) of ephemeral cloud assets, may be identified by the misconfiguration determination logic 710 acquiring parameters 730 associated with the properties of these ephemeral cloud assets and comparing the acquired parameters 730 to a set of known misconfiguration parameters for these types of ephemeral cloud assets.

Alternatively, according to another embodiment of the disclosure, a misconfiguration for the first cloud asset may be identified by the misconfiguration determination logic 710 acquiring the parameters associated with properties of the first cloud asset and comparing the acquired parameters to parameter settings in accordance with best industry practices for that cloud asset type. The misconfiguration results 750 are provided to the asset data store 450. The misconfiguration results 750 are considered in assessing a misconfiguration risk value (e.g., misconfiguration score) 850 that will determine whether (and what color) the first cloud asset is given for the visualization and a level that the first cloud asset is subjected to a cyber threat. This provides for prioritization of misconfigurations based on a visual review of the cloud environment and solves a long outstanding security monitoring issues due to a lack of comprehensive visibility and an in-depth understanding of the customer cloud environment.

As an illustrative example, a first cloud asset may feature an insecure setting. For instance, the first cloud asset may constitute a logical data store, such as an AWS S3 component, which is set to a “public” designation. As a result, the stored data with the S3 component is accessible to the public. In contrast with best or recommended industry practices, the S3 component should be set to a “private” designation. As another illustrative example, a first cloud asset may feature an outdated software instance (e.g., OS instance, device driver instance, etc.), which should have been updated in an enterprise-wide software update. As another illustrative example, multiple ephemeral cloud assets may have “open” ports allowing for remote access to the cloud asset from a remote computing device.

The acquired cost metrics 720 and/or misconfiguration results 750 determined by the asset management component 355 are provided to the asset data store 450 to provide further context to understand the behavior of corresponding cloud assets and/or cloud architectures pertaining to the cost metrics and/or misconfiguration.

Referring to FIG. 8, a block diagram of an exemplary embodiment of the risk assessment component 360 of the cloud security analytics subsystem 300 of FIG. 3 is shown. The risk assessment component 360 is configured to determine risk levels associated with each cloud asset and/or cloud architectures formed by a set of the cloud assets. Herein, according to this embodiment, the risk assessment component 360 features i) asset risk determination logic 800, ii) architecture risk determination logic 810, and iii) misconfiguration risk determination logic 820.

Herein, the asset risk determination logic 800 is configured to generate a risk value (score) 830, which represents the potential risk of the cloud asset being subjected to a cyber threat or compromised by a cyberattack. In determining the cloud asset risk value 830, a number of parameters are considered. These parameters may include, but are not limited or restricted to the following: (a) the age of the cloud asset 831 (as older cloud assets may be more susceptible to cyber threats than newer assets that may feature heightened security functionality); (b) the type of cloud asset 832 (as certain types of assets are less susceptible to attack, while others, such as logical data stores for example, are more susceptible to a cyber threat); (c) impact tags 833 (weighting values set by the enterprise to identify cloud assets that the enterprise considers important to its overall cloud environment operability to allow customers to be able to participate in the cloud asset risk level settings); (d) the oddity score 834 (a measure of how unusual or different the cloud asset is when compared to other assets to identify anomalous cloud assets that may already be subjected to a cyber threat); and/or (e) the model breaches 835 (identify cloud assets that may be susceptible to cyber threats through modeling).

Herein, these risk values 830 may be utilized in an aggregated distribution (e.g., an average or weighted average, summation, or other arithmetic-based computation) in the generation of cloud architecture risk values 840 and/or misconfiguration risk values 850 as described below.

The architectural risk determination logic 810 may be configured to compute a cloud architecture risk value 840, which represents the potential risk of the cloud architecture (i.e., a set of cloud assets) being subjected to a cyber threat or compromised by a cyberattack. In determining the cloud architecture risk value 840, a number of parameters are considered such as aggregated distributions of both a portion (subset) of the cloud asset risk values 830 that pertain to the cloud assets being part of the cloud architecture and a portion (subset) of the misconfiguration risk values 850 generated by the misconfiguration risk determination logic 820 as described below.

More specifically, according to one embodiment of the disclosure, the aggregated distributions may include i) a weighted average 841 of the cloud asset risk values 830 for the cloud assets forming the cloud architecture and ii) a weighted average 842 of misconfigured risk values 850 for the cloud assets forming the cloud architecture. The weighting may be conducted by applying a larger weighting value on those cloud assets having the highest risk levels in comparison to other cloud assets in the cloud architecture. This may align the cloud architecture risk to be more correlated to the riskier cloud assets.

In addition to the aggregated distributions, the cloud architecture risk value 840 may be based, at least in part, on a third parameter (impact tags) 843. When set (or altered) by a network administrator for the enterprise, the impact tags 843 allow the enterprise (or customer) to place importance on certain cloud architectures and/or certain cloud assets that may be included as part of a cloud architecture. The impact tags 843 apply further weighting based on a customer's perception as to what important to the customer and deserve a higher weighing as to protective risk in confirming that these assets are monitored more closely than other assets.

Referring still to FIG. 8, the misconfiguration risk determination logic 820 is configured to generate the misconfiguration risk value 850 based on one or more parameters. These parameter(s) may include a baseline risk 851 and an asset risk 852. The baseline risk 852 is assigned when the misconfiguration is created. The asset risk 852, on the other hand, is the risk value 830 of the cloud asset having the misconfiguration. The misconfiguration risk value 850 may be compared to predetermined risk thresholds to assign a priority to the misconfiguration for orderly handling of the most critical misconfiguration risks. The assignment of priority may be achieved by assigning the misconfiguration risk value (score) to an entity of a filtering element, assigning colors to the cloud asset in the visualization, or the like.

The above-described risks may be included as part of the cloud asset and/or cloud architecture metadata to be included as part of the graphical display and to coordinate a risk-based display hierarchy for the cloud assets and/or cloud architectures.

Referring now to FIG. 9, a block diagram of an exemplary embodiment of the cyber security appliance 120 of FIGS. 1A-1B is shown. The cyber security appliance 120 is configured to protect the enterprise, including but not limited to its customer cloud environments, from cyber threats. Various logic and components, such as AI-based models and modules of the cyber security appliance 120, cooperate to protect the customer cloud environment under analysis from cyber threats.

According to one embodiment of the disclosure, the cyber security appliance 120 may include a trigger module 900, a gatherer module 905, an analyzer module 910, a cyber threat analyst module 915, an assessment module 920, a formatting module 925, one or more AI models 930, a data store 935, an autonomous response module 940, domain module(s) 945, cloud module(s) 950, and/or a coordinator module 955. Herein, the AI models 930 are trained with machine learning on i) one or more pattern of life model 931 for entities in the network/domain/components under analysis (i.e. normal pattern-of-life model(s) 931), ii) one or more pattern of life models 932 for a cloud asset or a group of cloud assets, some may be ephemeral components, directed to an aggregate of behaviours associated with these cloud assets (i.e., cloud-based pattern-of-life model(s) 932), iii) one or more cyber threat hypothesis models 933 each adapted to form and investigate one or more cyber threat hypotheses on what are a possible set of cyber threats and their characteristics, symptoms, remediations, etc., and/or iv) potential cyber threats model(s) 934.

The cyber security appliance 120 is configured to protect a network/domain/asset and/or group of cloud assets from a cyber threat (insider attack, malicious files, malicious emails, etc.). In an embodiment, the cyber security appliance 120 can protect all of the cloud assets in the customer cloud environment(s) being monitored based on activity, for example, on an individual basis from monitoring communications going to and from the computing device on the network and/or cloud assets 140 within the customer cloud environment 130 of FIGS. 1A-1C. For example, via I/O ports 960, a domain module 945 may communicate with network sensors to monitor network traffic to and from the customer cloud environment as well as receive secure communications from software agents embedded in computing devices/containers. The steps below will detail the activities and functions of several of the components in the cyber security appliance 120.

The gather module 905 may have a series of one or more process identifier classifiers. A process identifier classifier can identify and track each process and device in the network or the customer cloud environment, under analysis, making communication connections. The data store 935 may be configured to cooperate with the process identifier classifier to collect and maintain historical data of processes and their connections, which is updated over time as the network is in operation. In an example, the process identifier classifier can identify each process running on a given device along with its endpoint connections, which are stored in the data store.

The analyzer module 910 is configured to cooperate with cloud-based AI model(s) 932 in the cyber security appliance 120 to confirm a potential cyber threat against a cloud asset or grouped cloud assets and/or detect cloud asset misconfiguration that makes the enterprise susceptible to a cyber threat. A cyber threat analyst module 915 is configured to cooperate with the AI models 930, including the cloud-based AI model(s) 932, to conduct a long-term investigation and/or a more in-depth investigation on potential cyber threats or cloud asset misconfigurations in the customer's cloud environment. An algorithm in the analyzer module 910 can cooperate with the gatherer module 905 to collect any additional data and metrics to support a possible cyber threat hypothesis.

More specifically, the analyzer module 910 and/or the cyber threat analyst module 915 can utilize the cloud-based AI model(s) 932 to conduct analytics other anomalies associated with activities encountered by a cloud asset and/or misconfigurations associated with the cloud asset based on a comparison of normal behaviors to detected behaviors. These anomalies may include, for example, deviations in normal behavior of a cloud asset or a group (two or more) of related cloud assets that may denote a cyber threat or a misconfiguration. The analyzer module 910 and/or the cyber threat analyst module 915 can cooperate with the AI models 930 trained on potential cyber threats in order to assist in examining and factoring these additional data points that have occurred over a given timeframe to see if a correlation exists between 1) a series of two or more anomalies occurring within that time frame and 2) possible known and unknown cyber threats or misconfigurations. The cyber threat analyst module 915 can cooperate with the internal data sources as well as external data sources to collect data in its investigation.

The cyber threat analyst module 915 in essence allows two levels of investigations of potential cyber threat attacks against a cloud asset or a group of cloud assets. In a first level, the analyzer module 910 and AI models 930 can rapidly detect and then autonomously respond to overt and obvious cyber threats. However, thousands to millions of low-level anomalies occur in a cloud asset or a cloud architecture under analysis. For example, advanced persistent threats attempt to avoid detection by making these low-level anomalies in the system over time during their attack before making their final coup de grâce/ultimate mortal blow against the domain or cloud environment being protected. The cyber threat analyst module 915 conducts investigations over time that can detect these advanced persistent cyber threats actively trying to avoid detection by looking at one or more of these low-level anomalies as a part of a chain of linked information.

The cyber threat analyst module 915 is configured to form and investigate hypotheses on what are a possible set of cyber threats and can also cooperate with the analyzer module 910 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI models 930 trained with machine learning on the normal pattern of life of entities (e.g., components, domains, cloud assets, group of cloud assets, etc.) in the system. The cyber threat analyst module 915 may be configured to submit to check and recheck various combinations/a chain of potentially related information under analysis until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted; and thus, needs a human to further investigate the anomaly of interest included in the chain of potentially related information.

It is contemplated that a data analysis process or any analytics can be conducted by algorithms/scripts to perform their function discussed herein; and can in various cases use AI classifiers as part of their operation. It is further contemplated that any portions of the cyber security appliance 120 or the cyber security system 150, when implemented as software, can be stored in one or more non-transitory memory storage devices in an executable format to be executed by one or more processors.

The gatherer module 905 may further extract data from the data store 935 at the request of the cyber threat analyst module 915 and/or analyzer module 910 on each possible hypothetical threat that would include the abnormal behavior or suspicious activity and then can assist to filter that collection of data down to relevant points of data to either 1) support or 2) refute each particular hypothesis of what the cyber threat, the suspicious activity and/or abnormal behavior relates to. The gatherer module 905 cooperates with the cyber threat analyst module 915 and/or analyzer module 910 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

As a starting point, for cloud asset analytics, the cyber security appliance 120 can use the trigger module 900 working with the analyzer module 910 and/or the cyber threat analyst module 915 with the cloud-based AI model(s) 932 to identify a cyber threat or misconfiguration based on a comparison between abnormal behavior and/or suspicious activity.

Many other model breaches of the cloud-based AI model(s) 930 trained with machine learning on the normal behavior of the customer cloud environment (e.g., cloud asset, group of cloud assets, architectures, etc.) can send an input into the cyber threat analyst module 915 and/or the trigger module 900 to trigger an investigation to start the formation of one or more hypotheses on what are a possible set of cyber threats that could include the initially identified abnormal identified abnormal behavior and/or suspicious activity. Note, a deeper analysis can look at example factors such as i) how long has the component, such as a cloud asset for example existed or is registered; ii) what kind of certificate is the communication using; etc.

Referring still to FIG. 9, the autonomous response module 940 is configured to take one or more autonomous mitigation actions to mitigate the cyber threat during the cyberattack. The autonomous response module 940 can reference a cloud-based AI model trained to track a normal pattern of life for cloud asset(s) (e.g. single cloud asset or a group of cloud assets) and/or its cloud architecture itself to perform an autonomous act of, for example, restricting a potentially compromised cloud asset(s) or cloud architecture having i) an actual indication of compromise and/or ii) merely adjacent to a known compromised node, to merely take actions that are within that asset's or cloud architecture's normal pattern of life to mitigate the cyber threat.

The chain of the individual alerts, activities, and events that form the pattern including one or more unusual or suspicious activities into a distinct item for cyber threat analysis of that chain of distinct alerts, activities, and/or events. The cyber threat analyst module 915 may reference the one or more machine learning models trained on, in this example, cloud architecture threats to identify similar characteristics from the individual alerts and/or events forming the distinct item made up of the chain of alerts and/or events forming the unusual pattern.

In the next step, the assessment module 920 with the AI classifiers, once armed with the knowledge that malicious activity is likely occurring/is associated with a given process from the analyzer module 910, then cooperates with the autonomous response module 940 to take an autonomous action such as i) deny access in or out of the device or the network ii) shutdown activities involving a detected malicious agent, iii) restrict devices and/or user's to merely operate within their particular normal pattern of life, iv) adjust access roles associated with the cloud architecture and/or certain cloud assets such as remove some user privileges/permissions associated with the compromised cloud account, and/or v) conduct offensive countermeasures to disable operations of a malicious server responsible for the malicious activity, such as a cyber threat or an on-going cyberattack.

The autonomous response module 940, rather than a human taking an action, can be configured to cause one or more rapid autonomous actions in response to be taken to counter the cyber threat, which may include disabling a source of the cyber threat (e.g., malicious server(s)). The disabling of the malicious server may be accomplished by disabling its ability to communicate with targeted systems.

Herein, the cyber security appliance 120 is configured for an architecture-based approach in operation with the cloud security system 150 of FIGS. 1A-1C. The cloud security system may provide an architectural representation of tens or hundreds of cloud assets along with the interconnections between the cloud assets to provide context as to the relevance of unusual activity alerts or misconfigurations. The behaviors associated with related cloud assets within the architectural representation may be evaluated against enhanced “pattern of life” modeling operating as normal behaviors associated with an aggregate of related, ephemeral cloud assets to identify cyber threats and misconfigurations.

Additionally, based on enumerated contextual data and operational data associated with the cloud asset(s) and risk assessment, the cloud security system 150 is adapted to more effectively and timely conduct respond actions, which improves the overall level of the enterprise. Also, the cloud security system 150 is adapted to provide a virtualization that prioritizes alerts based on risk (e.g., severity, cost, or the like) and/or organizes these alerts in accordance with a cloud remediation plan focused on displaying alerts in groupings that are targeted toward different security teams.

For example, as shown in FIG. 17, where security teams are organized to handle a particular enterprise's cloud account or narrower granularity such as particular cloud architecture(s), alert type(s), or cloud asset type(s), the virtualization can be arranged in accordance with the cloud remediation plan to provide security teams with alerts directed to that particular cloud accounts, cloud architecture(s), specific alert types, asset types, and/or cloud asset types. This visualization enables the security teams to resolve alerts in a more focused and efficient manner.

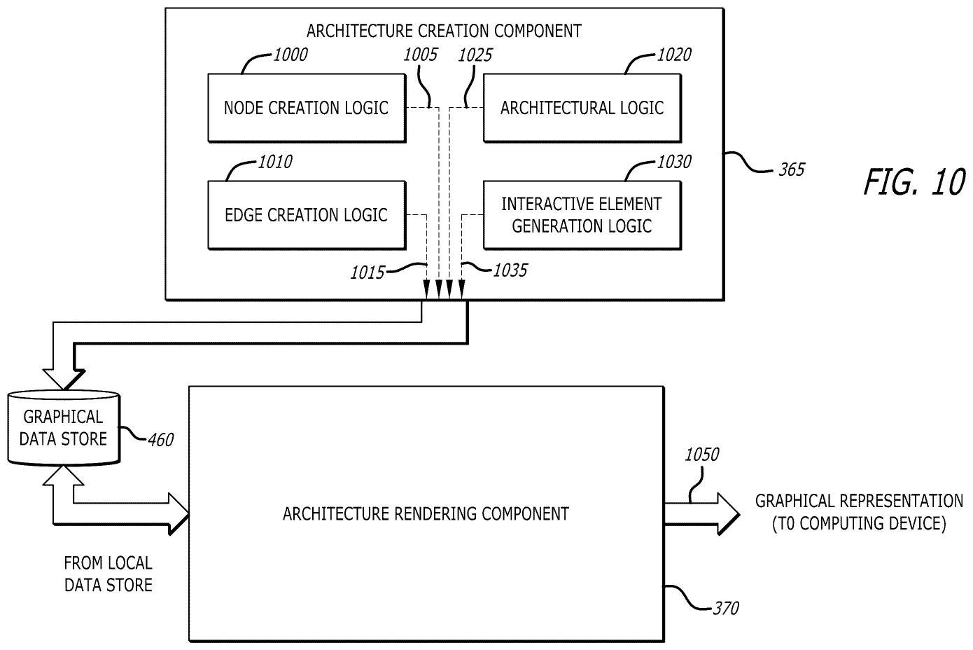

Referring now to FIG. 10, a block diagram of an exemplary embodiment of the architecture creation component 365 and the architecture rendering component 370 of the cloud security system 150 of FIG. 3 is shown. Collectively, the architecture creation component 365 and the architecture rendering component 370 generate and render visualizations of the customer cloud environment 130.

More specifically, the architecture creation component 365 features a node creation logic 1000, edge creation logic 1010, architectural build logic 1020, and/or interactive element generation logic 1030. The node creation logic 1000 is configured to generate node constructs 1005 based on metadata associated with the cloud assets obtained or received by the cloud asset enumeration component 340 of FIG. 3. Additionally, the edge creation logic 1010 is configured to generate edge constructs 1015, each of which includes communication-based information between a node pair and may be represented in the form of an edge (interactive connection) between the node pair. The node constructs 1005 and the edge constructs 1015 may be stored within the graph data store 460.

According to one embodiment of the disclosure, the architecture creation component 365 may further feature the architectural build logic 1020, which may be configured to generate cloud architecture constructs 1025 based on the node constructs 1005 and the edge constructs 1015. The cloud architecture constructs 1025 are code-based representations of a cloud architecture, where the cloud architecture constructs 1025 may also be stored within the graph data store 460. Herein, the cloud architecture constructs 1025 may be used to generate visual representations of one or more cloud architectures, each cloud architecture being a set of interconnected nodes.

Referring still to FIG. 10, the interactive element generation logic 1030 is configured to generate constructs 1035 associated with interactive graphical elements that, upon selection of at least one of these graphical elements, causes rendering of the metrics associated with that selected graphical element. These graphical elements may include objects such as graphical nodes and/or edges produced from their constructs that, when each is rendered, visually display metrics associated with that graphical element (e.g., metrics displayed within a dialog box). The graphical elements may further include selectable object within an interactive menu (described below). The element constructs 1035 are stored in the graph data store 460.

As further shown in FIG. 10, the architectural rendering component 370 is configured to operate as a user interface to contextualize and generate a visualization of cloud architecture(s), which provides context to an operator to allow him or her ascertain relatedness between cloud assets that influence alert prioritization to resolve alerts (e.g., misconfiguration alerts, NI alerts, etc.) and create or select more appropriate respond actions. Also, the architecture rendering component 370, operating in concert with the cloud remediation planning component 375 conducts a campaign-based approach to remediation, where issues or alerts may be grouped in accordance with a selected triage manner of handling such issues or alerts. For example, a remediation plan may be generated to group alerts in accordance with different security team or personnel responsibilities.

The architectural rendering component 370 may be further configured to perform cloud architecture reduction operations in which some sets of interconnected nodes may be duplicative with nodes of other cloud architectures. As a result, one or more sets of interconnected nodes may be merged with another set of interconnected nodes to generate a cloud architecture for display.

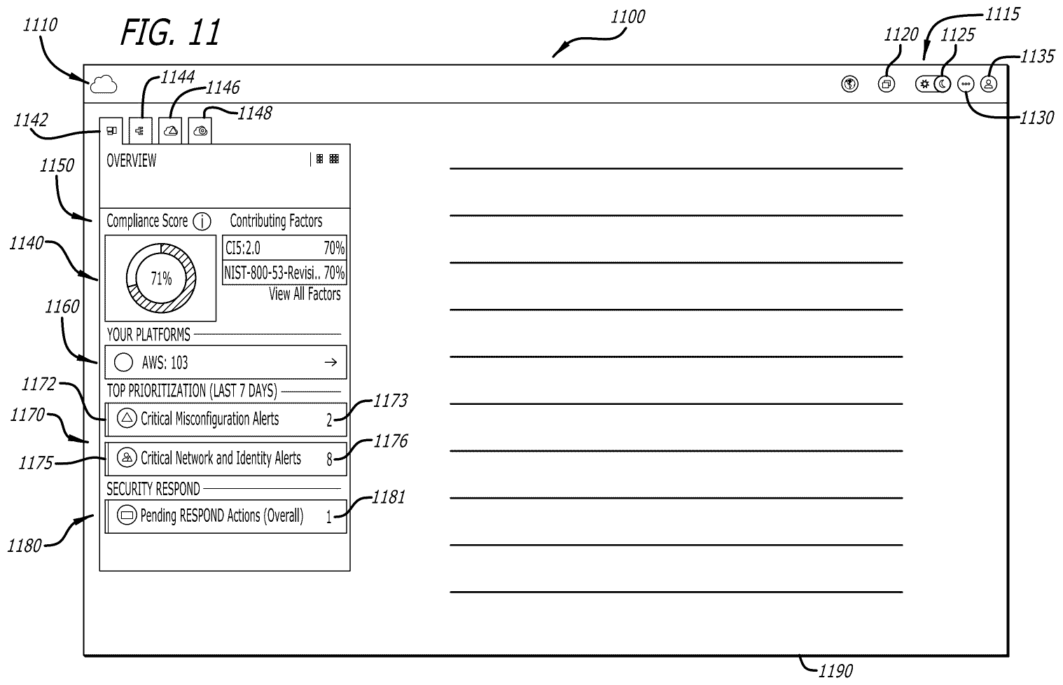

This “merging” operation is conducted to determine similarities (compatibilities) between these cloud architectures. The similarities may be based on a prescribed amount of node overlap between the two cloud architectures (e.g., percentage of compute engines shared, compute services shared, logical data stores shared, etc.), taking into account shared relationships (e.g., policies, privileges and/or permissions) pertaining to the cloud architectures and/or cloud assets associated with these cloud architectures. This is advantageous by providing a more holistic view of the customer cloud environment as shown in FIGS. 11-17. The architecture reduction operation is iterative, until the cloud architectures have been evaluated and a subset of these cloud architectures 1050 are available for rendering.

### IV. Exemplary Visualizations

Referring now to FIG. 11, an exemplary embodiment of a first display layout representing a cloud security interface 1100 generated by a graphic user interface (GUI) of a computing device, which operates in concert with the architecture rendering component 370 of FIG. 10, is shown. The cloud security interface 1100 features a plurality of display elements, including i) a universal toolbar 1110, ii) a collapsible, interactive menu 1140 that contains filters and key data, and iii) a main workspace 1190 where detailed information and graphical elements will appear. According to this embodiment of the disclosure, graphical elements within these display elements, upon selection, may generate additional elements (e.g., window regions, objects, etc.) with more detailed information which can be laid over the main workspace 1190.

As shown in FIG. 11, an illustrative example of the universal toolbar 1110 includes a plurality of icons 1115. For example, a first icon 1120 may be configured to access any minimized display element docked in the tray. The second icon 1125 may be adapted to change the primary color theme between light and dark mode for the cloud security interface 1100. A third icon 1130 opens a status and administration menu for the cloud security interface 1100, which provides access to deployment status, settings, and initial configuration while a fourth icon 1135 enables a log out from the cloud security system platform.

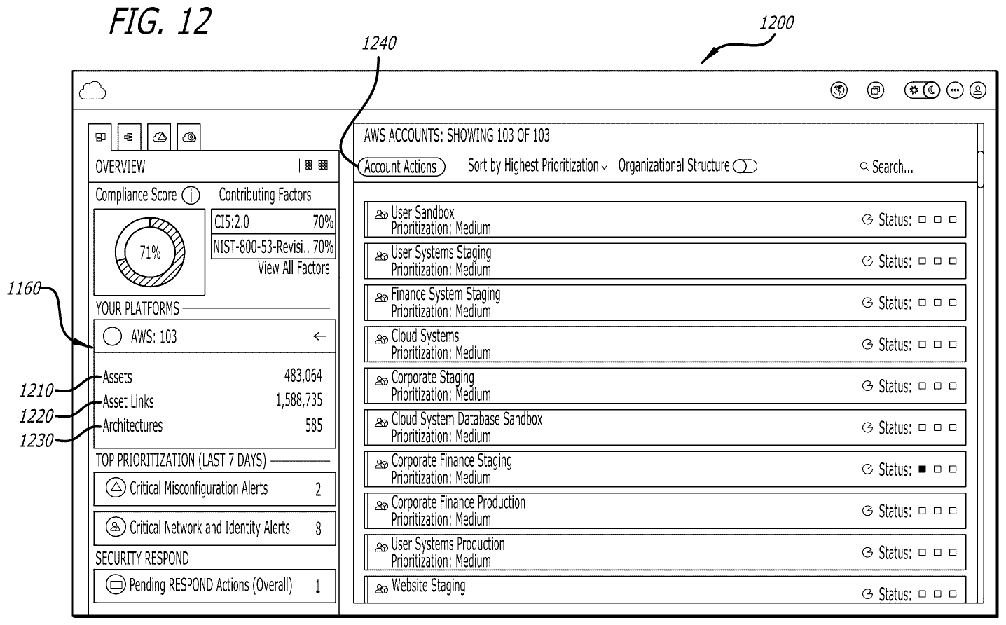

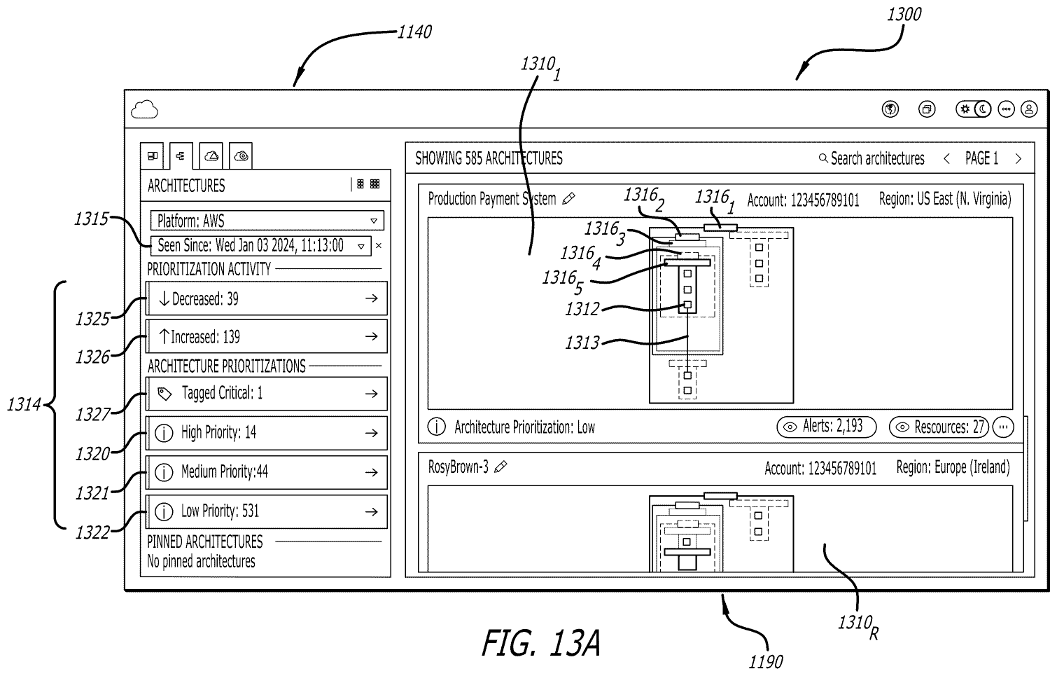

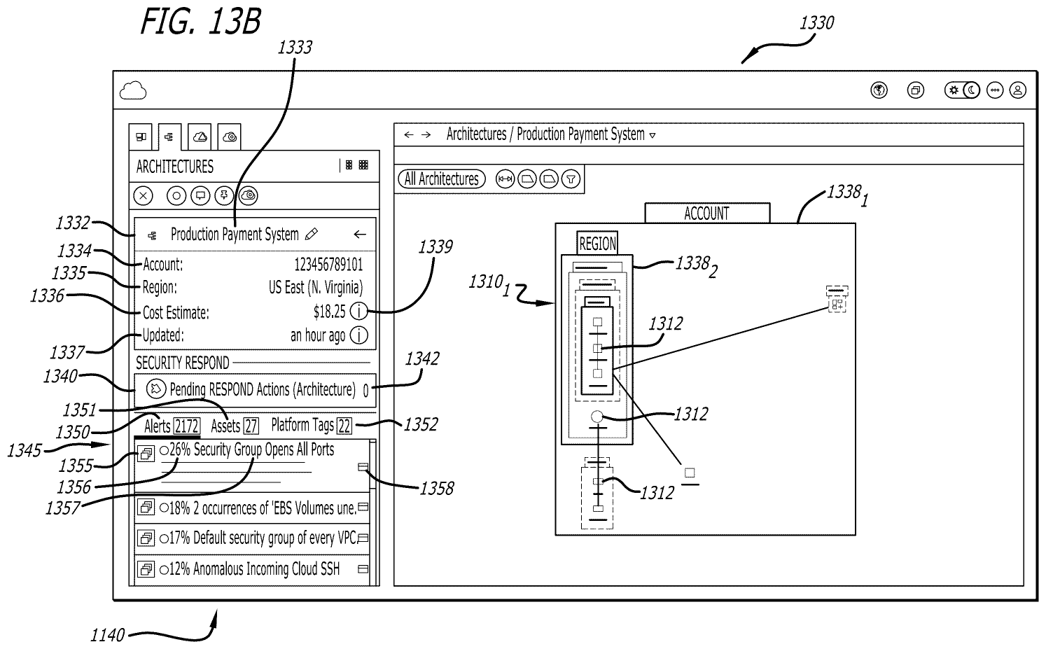

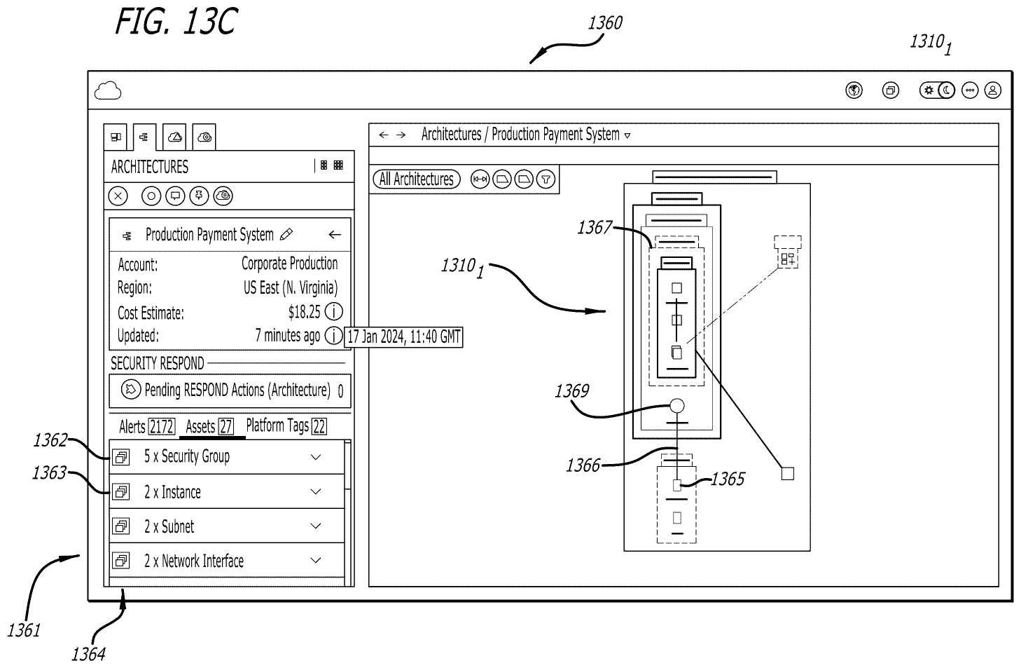

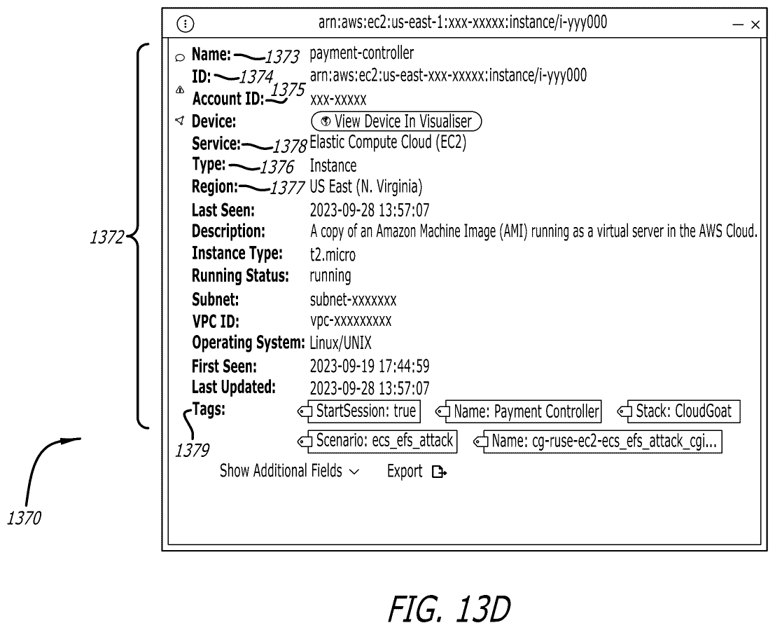

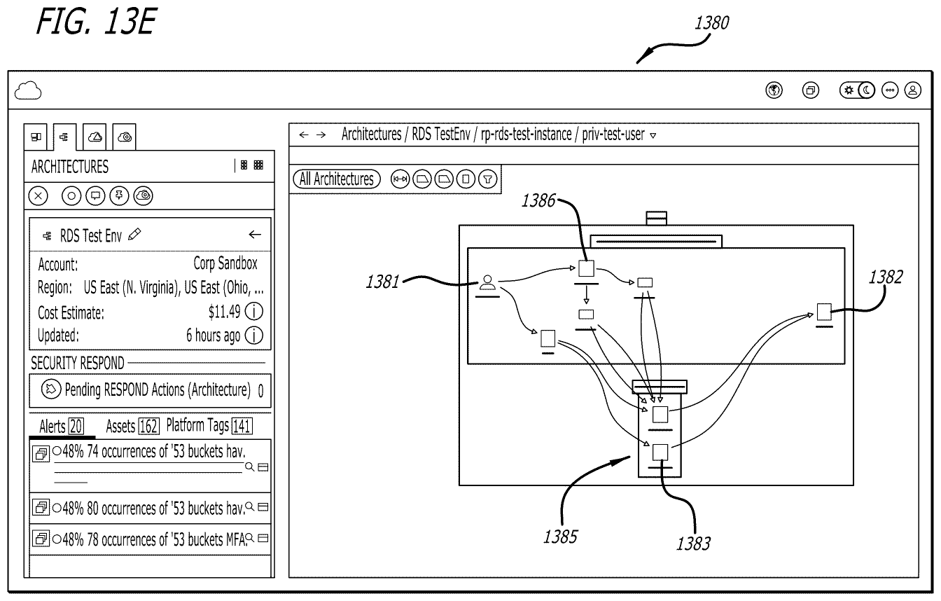

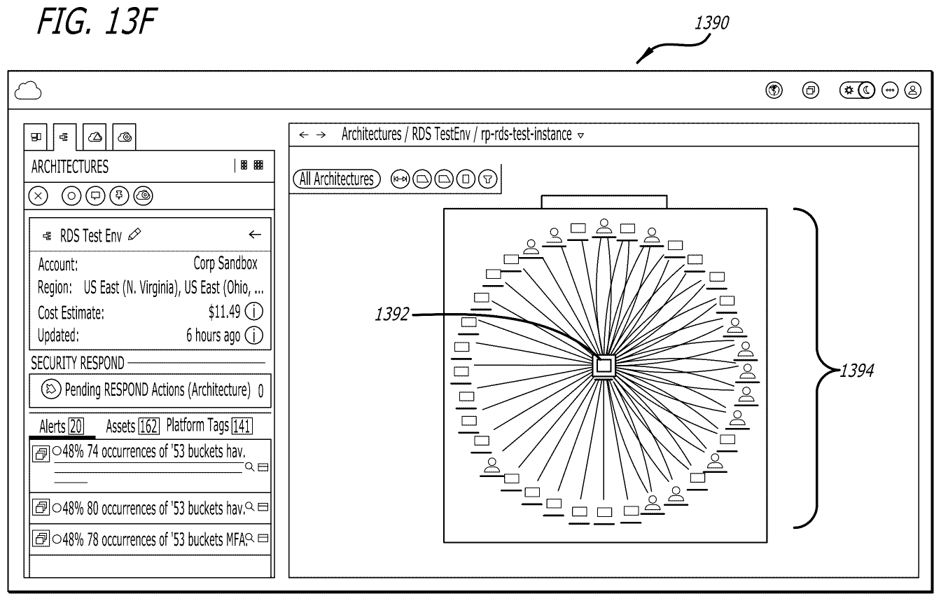

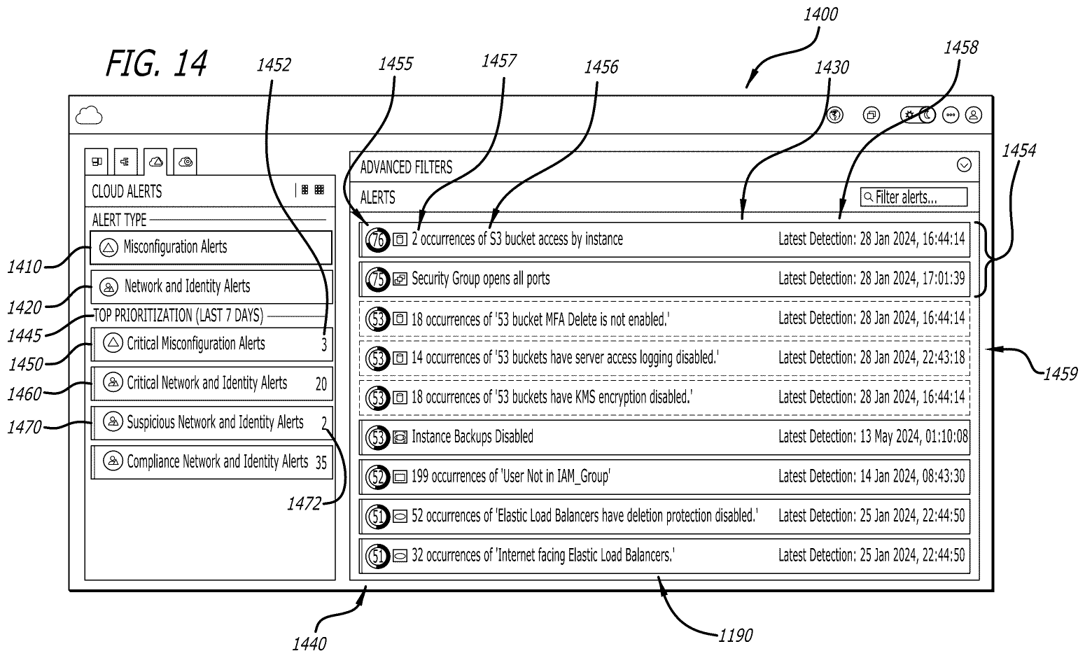

Referring still to FIG. 11, the interactive menu 1140 is positioned laterally from the main workspace 1190. The interactive menu 1140 allows for selection of four different display element combinations—i) an overview (default) display element 1142 (see FIGS. 11-12), an architecture display element 1144 (see FIGS. 13A-13F), an alert display element 1146 (see FIGS. 14-16), and a cloud asset display element 1148 that is configured to list cloud assets associated with an account, a platform (AWS™, Azure®, etc.), an architecture, or the like.

In general, according to one embodiment of the disclosure, the overview display element 1142 may be selected to operate as the landing page for cloud security. Thereafter, the interactive menu 1140 may surface graphical filtering elements associated with high-level statistics 1150 about the cloud security platform, platform metrics 1160, prioritized alerts 1170, and respond actions 1180 requiring human intervention.

The architecture display element 1144, when selected, is configured to surface graphical (filtering) elements that provide illustrations and information associated with the cloud architectures, namely interacting groups of assets in the customer cloud environment which form cloud-based infrastructure or systems. The cloud security system 150 of FIGS. 1A-1C automatically constructs these groups of interconnected assets by working out which components are connected as described above.

The alert display element 1146, when selected, is configured to surface graphical (filtering) elements directed to a plurality of alert types monitored by the cloud security system 150, such as misconfigurations and NI alerts. Misconfiguration alerts identify cloud assets which do not align with best practices or operational guidelines defined by cloud compliance frameworks. Leveraging upon ‘pattern of life’ monitoring and analysis as previously described, NI alerts highlight unusual, potentially malicious activity emerging within or impacting upon the customer cloud environment.

Finally, the cloud asset display element 1148, when selected, is configured to surface graphical (filtering) elements that provide an understanding of the customer cloud environment. This is accomplished by the cloud security system 150 enumerating cloud assets enriched by configuration and access policies along with contextual data about connected assets, asset priority, associated alerts, and other metrics. The cloud asset display element 1148 allows users to locate, investigate and interact with specific assets in this regularly updated database of information such as contextual information 320, supplemental metadata 325, enriched metadata 530, cost metrics 720, misconfiguration results 750 as described above and illustrated in FIGS. 3 & 5-7.

As shown in FIG. 11, the interactive menu 1140, upon selection of the overview display element 1142, is configured to provide a graphical representation including high-level statistics 1150 along with information associated with platform metrics, alerts, assets, and best-practice compliance across the customer cloud environment. The overview focuses on graphical filter elements-most critical alerts 1172 or respond actions 1180 needing immediate action—for operators with limited time to review. Each element can be used to drill down further as part of a threat investigation or compliance assessment workflow, or simply as part of an exercise to better understand the cloud landscape and how assets and systems interact.

According to one embodiment of the disclosure, the high-level statistics 1150 may be represented by a first selectable graphical (filtering) element 1152 (compliance score element) and a second selectable graphical (filtering) element (contributing factors element) 1155. These selectable elements 1152 and 1155 simplify cloud security posture management by allowing operators to quickly visualize how their cloud environment compares against key guidelines drawn from multiple risk and compliance frameworks (e.g., ≥20 risk and compliance frameworks). These risk and compliance frameworks provide guideline metrics from industry bodies, regulators, and vendors as to best practice operations in the cloud; where these frameworks are intended to ensure cloud assets, policies and processes operate in a secure manner.

As part of its standard operations, as shown in FIG. 1A, the cloud security system 150 assesses the configuration of assets, policies, and the overall cloud environment against guideline metrics 155 from risk and compliance frameworks. These guideline metrics include general cloud-based best practices that are not unique to a specific framework. When a cloud asset is determined to be non-compliant with these best practice recommendations, or to be insecure in some way, a misconfiguration alert is raised.

Referring back to FIG. 11, the compliance score element 1152 identifies a compliance score 1153, which identifies how closely the current operational state of the customer cloud environment aligns with these best practice recommendations. With respect to the compliance score 1153, fewer misconfiguration alerts may contribute to a higher score. Also, resolving misconfigurations improves the score assessment.

As many frameworks may have significant overlap in their recommendations and assessment criteria, the compliance score 1153 is therefore averaged across the risk and compliance frameworks. Individual risk and compliance frameworks can be reviewed under the contributing factors element 1155, which is configured to list the security frameworks which are contributing to the overall compliance score 1153. Each framework is given a percentage score-a low score indicates the cloud security system 150 found a number of misconfigurations which are covered in the framework assessment criteria. By resolving misconfigurations covered by the risk and compliance frameworks improves compliance by the customer cloud environment and will raise the overall compliance score 1153. As an illustrative example, NIST-800-53-Revision-5 framework 1156 and CIS: 2.0 framework 1157 are shown as different risk and compliance frameworks. The ‘View All Factors’ graphical (filtering) element 1158, when selected, is configured to display all other risk and compliance frameworks and the percentage compliance. To see the exact alerts contributing to the overall compliance score, the risk and compliance frameworks (e.g., frameworks 1156 and 1157) are selectable, and upon selection, the alert display element 1146 is effectively selected to generate a display element, where misconfigurations that are applicable to the chosen framework are shown.

As further shown in FIG. 11, positioned under the compliance score 1153, the platform metrics graphical (filtering) element 1160 is configured to provide a breakdown of the cloud platforms being monitored by the cloud security system 150. Besides each cloud platform is a count of the constituent accounts the cloud security system 150 is monitoring. By selecting a cloud platform to review, details of the cloud platform may be provided and details of specific monitored accounts within the cloud platform may be provided in the main workspace 1190 upon selection of an account actions graphical element 1240 as shown in FIG. 12.

Referring still to FIG. 11, the interactive menu 1140, upon selection of the overview display element 1142, further include additional selectable graphical (filtering) elements 1170 and 1180 for quick access to critical alerts and respond actions requiring human intervention. For instance, positioned underneath the platform metrics graphical element 1160, a plurality of alert types are listed in graphical filtering elements: critical misconfiguration alerts 1172 and critical network and identity (NI) alerts 1175. For each alert type, over a prescribed period of time (e.g., last 7 days), a predetermined number of NI alerts having the top prioritization scores (deemed critical) are displayed along with a predetermined number of active misconfigurations deemed critical based on risk scores (as computed in FIG. 8 for example) exceeding a risk threshold as described above.

According to one embodiment of the disclosure, the ‘misconfiguration alerts’ graphical element 1172 identifies cloud assets, policies and processes which do not align with the best operating practices outlined by cloud risk & compliance frameworks. “Critical” misconfiguration alerts-assigned a compliance score above a risk threshold (e.g., 70 out of a 100)—indicate a severe issue which should be addressed and mitigated as a priority.

As shown, a ‘critical’ misconfiguration alerts count object 1173 allows an operator to quickly visualize how many critical misconfigurations are currently active and detected within the prescribed period of time. By selection of the count object 1173, the alert display element 1146 is effectively selected to generate a display element, where the critical misconfiguration alerts are illustrated to begin a mitigation workflow.

The ‘network and identity’ (NI) alerts graphical element 1175 highlight unusual, potentially malicious activity emerging within—or impacting upon—the customer cloud environment. The NI alerts graphical element 1175 may include ‘critical’ NI alerts count 1176, namely an object that indicates a behavior category representing the highest severity of anomalous or potentially malicious behavior has been detected. The critical NI alerts count 1176 allows an operator to quickly see how many critical anomalies have emerged within the prescribed period of time. These critical NI alerts may be surfaced by selecting the critical NI alerts count 1176, where the alert display element 1146 is effectively selected to generate a display element in which the critical NI alerts are illustrated to begin a cyber threat investigation for these alerts (e.g., through analysis of contextual and metadata pertaining to the alerts).

Referring still to FIG. 11, the interactive menu 1140 may further include the ‘respond action’ graphical (filtering) element 1180, where the respond actions leverage the power of the ‘pattern of life’ modeling developed across the platform to respond, contain, and neutralize emerging threats across the entire digital estate. Significantly anomalous or concerning behavior targeted by the network and identity alerts can trigger a respond action targeted to restrict or entirely shut down the activity.

The respond action graphical element 1180 displays a count 1181 of pending respond actions at the time of viewing, where cloud-native respond actions may include role modification and security group restriction, ensuring targeted response for cloud assets. More specifically, the pending respond actions may feature i) actions created by the autonomous response module 940 of FIG. 9 but awaiting human approval before activation and ii) actions which could not be applied by cloud security system 150, requiring human resolution to proceed.

For specific behaviors or operating modes, the cloud security system 150 can create recommended actions but not take them unless approved by a user; actions created but waiting for human confirmation to take affect are therefore referred to as “pending” actions, as they are pending human approval. Although not shown, the pending respond action count 1181 may include attempted actions, which are actions which were blocked or interrupted.

Referring to FIG. 12, an exemplary embodiment of a second display layout 1200, which represents expansion of the platform metrics graphical element 1160 within the interactive menu 1140, is shown. When the platform metrics graphical element 1160 is expanded, high-level statistics about the assets of the cloud security system 150 are discovered and linked together within that cloud environment. The expanded representation displays three count values: an assets count 1210, an asset links count 1220, and an architectures count 1230.

In general, as described above, assets are logical and/or physical components in the customer cloud environment enumerated by the cloud security system 150. Some assets are static logical components such as compute engines or data stores. Other assets may represent ephemeral cloud assets, such as some types of virtual machines, security groups or instance, which may exist in tandem with other assets.

Enumeration of cloud assets is initially performed during initial authentication and then at intervals afterwards. Observed changes to cloud services and asset types may also trigger the cloud security system 150 to re-scan the customer cloud environment to update the asset count 1210. This ensures the cloud security system 150 remains aware of the cloud assets, whether newly created, modified, or deleted. This count will therefore change frequently as the customer cloud environment changes.

The asset links are logical connections that the cloud security system 150 creates between discovered assets. The asset links may be established due to network traversal rules, as for example, a virtual machine is permitted by intermediary firewall rules to contact another. An asset may be directly coupled to another asset or may be indirectly coupled to that asset via based on permitted access via an intermediary asset. For example, one asset may be permitted to write data to the other asset to a role or access policy. The asset links count 1220 maintains a count of the number of active links maintained between assets of the customer cloud environment.

Through these asset links, the cloud security system 150 generates interconnected groups of assets which clearly operate as a system or related infrastructure in the cloud. These groups are referred to as “architectures,” which are the central part of the cloud security system 150. Formed from interacting groups of assets in the customer cloud environment, the cloud security system 150 automatically constructs the architectures (i.e., group(s) of interconnected assets) by working out which assets are linked and likely represent cloud-based infrastructure or systems. The architectures count 1230 is represented within the platform metrics graphical element 1160.

The interconnected nature of assets allows risk factors to propagate organically across the customer cloud environments. Alerts associated with a particular cloud asset can therefore impact the priority of all connected cloud assets, and of the architecture as a whole. Architectures are constantly evolving alongside the customer cloud environment and may change as cloud assets are created and deleted. Some assets, such as global policies or organization-level entities, might exist in many architectures at once.

Referring now to FIG. 13A, an exemplary embodiment of a third display layout 1300 representing illustrations of one or more architectures (diagrams) 13101-1310R (R≥1) upon selection of the architecture display element 1144 of FIG. 11, each architecture 1310 featuring cloud assets 1312 interconnected by asset links 1313 is shown. Herein, the architecture(s) 13101-1310R are central to operability of the cloud security system 150. Formed from the architecture(s) 13101-1310R featuring interacting groups of cloud assets in the customer cloud environment (grouped cloud assets), the cloud security system 150 automatically constructs the cloud architectures by determining which assets are linked (e.g., communicatively coupled together) and likely represent cloud-based infrastructure or systems and renders graphical nodes and interconnection lines to represent the cloud assets, asset links, and/or grouped cloud assets that form the architectures. Each of the grouped cloud assets may be represented by a box 13161-1316B (B≥1), which may be labeled by a selected cloud asset group, such as account 13161, region 13162, VPC 13163, zone 13164 and subnet 13165.

More specifically, the cloud security system 150 discovers assets across the customer cloud environment by enumeration via the cloud asset enumeration component 340 of FIG. 3. Then, the cloud security system 150 simulates access restrictions for both identify and access monitoring (IAM) and network policies, mapping the routes that exist between the enumerated cloud assets along with access criteria such as users, and/or roles. Once mapped, the architecture creation component 365 of FIG. 3 automatically assembles these cloud assets and links into architectures, namely grouped collection(s) of components that interact closely, representing connected systems and infrastructure in the customer cloud environment. Discovery and analysis are entirely automated and repeated regularly, ensuring the best possible reflection of the active cloud environment. The architecture rendering component 370 of FIG. 3 generates the visual representations (nodes, interconnection lines, bordering perimeters, etc.) in the formation of the architectures.

By visualizing cloud assets as interconnected components in lieu of interacting with simple lists of assets divorced from the context of operation, the operators can view and interact with assets in a far more natural, accessible way; one that mirrors the projects and infrastructure deployed by technical teams. The operators can quickly i) visualize how a misconfigured cloud asset could impact other cloud assets and the system at large and/or ii) track how a compromise may spread across interconnected cloud assets, without having to manually map the myriad of possible connections between cloud assets.

Communications with the end-users who deploy and administer cloud assets is also simplified. Visualization and understanding are not the only benefits of this architecture-first approach; the interconnected nature of assets allows priority and risk factors to propagate organically across the customer cloud environment. For example, an alert created for an asset impacts the priority of all connected assets, and of the architecture as a whole. A ‘pattern of life’ detection also benefits from the expanded context, combining behavioral modelling with asset and system-level context.

Referring still to FIG. 13A, switching to the architecture layout from an overview layout of FIGS. 11-12 may cause the main workspace 1190 to be populated with illustrative architectures that the cloud security system 150 has constructed from the uncovered cloud assets. Within the interactive menu 1140, graphical filtering elements 1314 are configured to allow returned architecture tiles (node representations) to be filtered by a specific priority such as architectures that have changed priority since a baseline date, those architectures marked as critical to operability of the customer cloud environment, or those architectures manually pinned by an operator.

The “Seen Since” graphical (filtering) element 1315 enables a timing baseline for increased and decreased architecture priority. By default, the timing baseline is set at 2 weeks, but the timing baseline may be set to another duration. To illustrate cloud asset architectures which have only recently increased or to see the impact of recent mitigation activities, the ‘Seen Since” graphical element 1315 may be altered to a duration that is lesser in duration (e.g., 1 day).

Every architecture is assigned a prioritization scoring (priority) in accordance with a prescribed granularity such as high, medium, or low priorities 1320-1322. The prioritization scoring may be used to highlight cloud asset architectures with alerts requiring immediate attention or with high-impact, high-cost cloud assets, and thus, better focus operator attention on cloud asset architectures when her or his investigation time is limited. Also, some architectures with high-impact cloud assets may remain highly prioritized at all times, ensuring that even minor alerts towards these architectures should be timely confirmed by an operator to avoid any problems to critical systems.

As shown in FIG. 13A, a ‘decreased’ priority graphical (filtering) element 1325 identifies the number of architectures that have experienced a reduction in misconfigurations, alerts or high impact assets since the time displayed in the “Seen Since” graphical element 1315. Upon selection, the particular architectures with decreased priority may be identified. Similarly, the ‘increased’ priority graphical (filtering) element 1326 identifies the number of architectures which have seen a rise in misconfigurations, alters or high impact assets since the time displayed in the “Seen Since” graphical element 1315. Upon selection, the particular architectures with increased priority may be identified. Newly discovered architectures are classified as increased risk until a baseline can be established.

Architecture prioritizations are additional filters that can be applied and selected to generate visualizations of architectures assigned a certain priority. These filters are applied in addition to those under “Prioritization Activity”, but only one of the prioritization graphical (filtering) elements (high, medium, low) 1320-1322 may be selected at any time. Architecture prioritization can be changed over time as new alerts emerge, or as individual assets within it increase in priority. Resolving alerts present on assets in the architecture-such as highly scored misconfigurations—also decreases the architecture priority.

Also, architecture prioritization can be manually increased by tagging the architecture as critical. To do so, an operator may select an architectural tile and selectively mark the tile (and architectural component) as critical. Architectures can also be unmarked in the same way. The tagged architectures may be illustrated by a tagged graphical (filtering) element 1327 for quick reference. In the event of a remapping activity (caused by presence of new cloud assets) in which the architecture may have a different set of cloud assets and a different prioritization, the tag expires, and the architecture would need to be tagged again.

Architecture tiles in the main workspace 1190 display key information about the grouped cloud assets, any active alerts on the contained cloud assets, and the cloud accounts they reside in. The main workspace 1190 contains individual architectures, represented as tiles. Multiple architectures may be displayed per display layout.

Each architecture may be configured to identify a cloud platform account in which it is situated. Accounts are identified by name or, if not available from the cloud platform, account identifier (ID). Also, each architecture tile may be configured to display the regions where the contained cloud assets are deployed. Most architectures will be limited to one or two close regions, but some larger architectures may span multiple regions or accounts.

Herein, the architecture tiles operate as a snapshot visualization of the architecture itself. For every architecture, the cloud security system 150 creates an architecture representation—an interactive visualization of the cloud assets as architecture tiles and interconnecting lines as communication paths or relationships between them. The visualization allows an at-a-glance recognition of the size, complexity, and composition of the architecture. If desired, the location of assets within the diagram can be manipulated and the snapshot updated.

Associated with the architecture visualization, the architecture prioritization graphical elements (high, medium, or low) 1320-1322 may focus an operator's attention as to cloud assets or groups of cloud assets to investigate when investigation time is limited. The architecture prioritization graphical element 1320 highlights architectures with severe alerts requiring critical attention and/or architectures containing high-impact, high-cost cloud assets.

Referring now to FIG. 13B, an exemplary embodiment of a fourth display layout 1330 representing more detailed illustrations of alerts associated with a selected architecture (i.e., production payment system cloud architecture 13101) of FIG. 13A is shown. Upon selection, different graphical elements within the interactive menu 1140 are displayed.

Herein, according to one embodiment of the disclosure, the collapsible, interactive menu 1140 features a platform metrics display 1332, which includes a plurality of selectable, graphical elements. The graphical element may include, but are not limited or restricted to i) a name 1333 of the cloud asset architecture, ii) account identifier 1334, iii) region identifier 1335, iv) cost estimates 1336, and v) update information 1337. The architecture name 1333 is assigned with an auto-generated title on creation, but where the cloud asset architecture 13101 can be renamed to better reflect the infrastructure or systems contained within.

The account identifier 1334 includes information concerning the entity associated with the cloud asset architecture 13101 and the region identifier 1335 indicates where the cloud assets 1312 associated with the cloud asset architecture are located. Both the account identifier 1334 and the region identifier 1335 are also depicted on the cloud asset architecture 13101 as groupings represented by colored enclosure lines 13381 and 13382.

Cloud security system 150 can also display cost estimates 1336 associated with the cloud asset architecture 13101, which assists users to understand which prioritized architectures may also represent the highest financial risk if compromised. When cost information is available for the cloud assets, the cost estimate may pertain to an estimated average cost of operation for all the cloud assets currently present in the cloud asset architecture 13101. Costs take into account both cloud asset cost and data ingress/egress cost. More details regarding the cost estimate analytics may be displayed upon selecting an information icon 1339.

Cloud assets are frequently altered, and thus, the cloud security system frequently enumerates the cloud assets present in the customer cloud environment to identify the cloud asset architecture along with the current metrics associated with that architecture. The updated information 1337 indicates when the cloud asset architecture was last altered due to changes in the customer cloud environment.

Referring still to FIG. 13B, the interactive menu 1140 further includes a graphical (filtering) element 1340 within the fourth display layout 1330 (hereinafter, “pending respond action element”), which illustrates current actions in response to detected potential malicious activity or significant anomalies that deviate from the ‘pattern of life’. The pending respond action element 1340 displays a count 1342 of pending and/or attempted actions in the cloud security system 150 at the time of viewing. Examples of pending actions may include, but are not limited or restricted to i) actions generated by the autonomous response module 940 of FIG. 9 and awaiting human approval before activation and/or ii) actions which could not be applied by the cloud security system 150, requiring human resolution to proceed. The attempted actions are actions that may have been blocked (due to settings) or interrupted. Selection of the pending respond action element 1340 generates another display element that identifies the pending and/or attempted actions.

As shown in FIG. 13B, the fourth display layout 1330 further includes architecture details graphical elements 1345, which includes an alerts tab 1350, an assets tab 1351 and a platform Tags tab 1352. These tabs 1350-1352, when selected, provide an interactive list of prioritized alerts, assets, or platform tags applicable to cloud assets within the cloud asset architecture 13101.

Upon selection of the alerts tab 1350, as shown in FIG. 13B, the interactive menu 1140 of the fourth display layout 1330 displays a list of active misconfiguration alerts and NI alerts for assets within the cloud asset architecture 13101. The alerts tab 1350 displays entries associated with misconfigurations and any NI alerts created over a prescribed period of time (e.g., two weeks). The entries may be sorted by severity score.

Herein, each entry may be composed of an icon representing the affected cloud platform service or asset type 1355, a severity score 1356 (e.g., value between 1-100 with the highest value indicating greater severity), a title 1357 describing the detected alert (e.g., misconfiguration, activity, etc.) and a window icon 1358 to open a detailed view of the detected alert. Misconfiguration alerts may also list a count of how many assets the misconfiguration is applicable to. Hovering a selection element (e.g., cursor or pointer) over the alert title 1357 may cause more details about the detection type to be displayed.

Referring to FIG. 13C, an exemplary embodiment of a fifth display layout 1360 representing more detailed illustrations upon selection of the assets tab 1351 associated with the cloud asset architecture (i.e., production payment system cloud architecture) 13101 is shown. Upon selection, the assets tab 1351 displays a list of cloud assets 1361 contained with the architecture. The cloud assets 1361 may be grouped by type and may be sorted from largest to smallest grouping as shown (e.g., 5-security groups 1362, 2-instances 1363, etc.). Beside each grouping includes an icon 1364 representing the cloud platform service or type the asset belongs to—hovering over one of the icons 1364 for a cloud asset grouping may also display the service name or type (e.g., Simple Storage Service “S3”) and/or highlight the corresponding nodes on the cloud asset architecture 13101. Further selection of the grouped cloud asset type may cause generation of the individual named cloud assets. Upon selection (e.g., active selection “click” or “double-click” by a selection element, hovering over, etc.) of a particular cloud asset, an identifier of the cloud asset from the cloud platform may be provided.

Referring still to FIG. 13C, any external platforms allow assets to be tagged for identification or automation purposes. The cloud security system 150 retrieves these tags and stores them as enrichment metadata for each cloud asset. The platform tags tab 1352 lists all the external platform tags retrieved for assets in the architecture, grouped by the tag itself. Upon selection of a particular tag, the corresponding tagged node in the architecture diagram is highlighted.

The cloud asset architecture 13101 features three primary elements: assets 1365, edges 1366, and groupings 1367. The cloud assets 1365 are represented by icons depicted on the cloud asset architecture 13101, which represent the most basic building block for cloud asset architecture diagrams. These cloud assets 1365 are communicatively coupled to other entities within the cloud asset architecture 13101, operating as an overall system.

Herein, as shown in FIG. 13C, the cloud assets 1365 are represented by different individualized icons dependent on the asset type. Grouped assets are indicated by two or more icons stacked on top of one another. The icons may be shaded or outlined with or feature a displayable object of a first color to identify that the cloud asset (or grouped cloud assets) is associated with an active misconfiguration alert. Additionally, the icons may be shaded or outlined with or feature a displayable object of a second color to identify that the cloud asset (or grouped cloud assets) is associated with an active NI alert. These cloud asset icons can be moved around the workspace as desired.

As further shown in FIG. 13C, the edges (interconnections) 1366 represent relationships between cloud assets. These relationships may identify an ability for network traffic to pass between the cloud assets, where one cloud asset may be leveraged to gather data from or exchange data with the other cloud asset or one cloud asset may reside in or belong to another cloud asset.

More specifically, cloud assets may be linked due to network traversal rules, as for example, a virtual machine is permitted by intermediary firewall rules to contact another. Assets may be directly attached to one another or be connected by permitted. Through these links, the cloud security system 150 builds up interconnected groups of assets to create the wider architecture as a whole.

Herein, the edges 1366 are relationships between the cloud assets 1365. Evaluating each possible connection between cloud assets 1365 and then linking them together with the edges 1366 is how the cloud security system 150 constructs the cloud asset architecture 13101. The cloud security system 150 may be configured to prioritize visualization of certain relationship edges such as those edges which represent an ability to control another cloud asset (e.g., read/write activity), those edges which represent an ability to modify data, and those edges which represent traffic to/from the wider internet. For grouped cloud assets, hovering a node will display the edges for all of the grouped cloud assets.

There are a plurality of different edge types. In one example, an EC2 instance is situated within a subnet, which is itself inside a virtual private cloud (VPC), and then within a wider account. This relationship is referred to as a “contains relationships,” which are typically depicted using groupings—color boxes which are drawn around a group of related assets. Another edge type is a traffic-based edge relationship—security group applied to the EC2 instance, which permits the EC2 instance to contact other EC2 instances within the same subnet over TCP/443. Yet another edge type is an assumption-based edge—the EC2 instance is then permitted to assume a role to access secrets stored in a secret management service. Via this role, this secret management service can access stored secrets through a policy permitting listing and access of secrets, which is another edge type referred to as an access-based relationship. Lastly, a database instance in the same VPC possesses a secret key asset used to encrypt the data contained within it. The relationship between this database asset and key asset is referred to as a possession-based (has) relationship, as one belongs to the other. The edges may be designated differently (e.g., color, line width or type, etc.) to provide the operator with better understanding of the relationships between the cloud assets.

As further shown in FIG. 13C, in some cases, the cloud security system 150 may be configured as a group of assets with some association between these assets. Hence, the “groupings” 1367 are boxes drawn around the group of nodes (assets) to represent a characteristic shared by the grouped nodes. Each grouping, created for visualization benefit, is labelled to clearly describe its purpose. For example, a grouping box with the label “Zone: us-east 1a” represents the boundaries of a subnet asset in the cloud platform, which then groups together the assets within it (such as EC2 instances).

Most groupings represent logical, hierarchical relationships between cloud assets. For example, an instance is located within a subnet which itself resides within a VPC—this instance is displayed on the diagram within a subnet-level grouping, then within a VPC-grouping, and then an account-level grouping. A “shared accessed cloud asset” grouping is another example of this grouping. This grouping often contains many services and reachable assets, so may be collapsed by default. These groupings may be generally referred to as “grouped cloud asset.”

Referring now to FIG. 13D, an exemplary embodiment of a secondary display layout (first sub-diagram) 1370 representing detailed of a graphical element generated from selection of a cloud asset node (e.g., payment controller 1369) of FIG. 13C is shown. Herein, selection of the region identifier 1335 causes illustration of information (metadata) associated with the node 1369 of the cloud asset architecture 13101. The display element 1371 includes metadata 1372 associated with the compute engine (EC2) represented as the node 1369, including name 1373, cloud service identifier 1374, cloud account identifier 1375, resource type 1376, location 1377, service type 1378, and/or impact tags 1379. Additionally, although not shown, log data may be available. The metadata 1372 provides context as to the characteristics of this “compute engine” node 1369 and, from the metadata, the operability and/or purpose of the cloud asset may be determined.

Referring now to FIG. 13E, an exemplary embodiment of another secondary display layout representing more detailed illustrations of permissions associated with one of the cloud asset architectures of FIG. 13A. According to one embodiment of the disclosure, there are two types of sub-diagrams which visualize the routes access and role assumption can flow within the customer cloud environment: a permissions breakdown sub-diagram 1380 and an access breakdown sub-diagram 1390. These sub-diagrams provide additional understanding how a cloud asset may interact with or act upon another cloud asset.

As shown in FIG. 13E, the permissions breakdown sub-diagram 1380 depicts how one asset can access or assume the other in some way. The permissions breakdown sub-diagram 1380 may be accessed via a selectable permission breakdown entry available in one of the alert tab 1350 or asset tab 1351 or selection (right-click) for a cloud asset depicted in an access sub-diagram 1390 described below and shown in FIG. 13F.

Herein, the permissions breakdown sub-diagram 1380 is configured to visualize routes that permit access between a source (cloud) asset 1381 and a target (cloud) asset 1382. Herein, all possible IAM routes that permit access from the source asset 1381 to the target asset 1382 are depicted. Often, some of these routes between the source asset 1381 and the target asset 1382 are unintended. For example, an overly permissive policy at the target asset 1381 or an intermediary cloud asset 1383 can allow an asset-if compromised by a malicious actor—to chain together multiple assumptions and policies to achieve access, even if a straightforward route has never been explicitly defined.

Unlike architecture diagrams or access sub-diagrams (described below), the permissions breakdown sub-diagram 1380 depicts a flow from one single asset to another. This flow may pass through multiple intermediary assets 1385 or be connected by multiple alternative routes, but feature a single starting and ending point. One of these assets may be a policy asset 1386, which is not typically depicted on architecture diagrams, but can be included in the permission breakdown sub-diagram 1380 to clearly visualize the attached policy that has permitted the access. This ensures that an operator knows which policy should be altered or detached to sever the access.

Referring now to FIG. 13F, the access breakdown sub-diagram 1390 represents more detailed illustrations of cloud asset access for one of the cloud asset architectures of FIG. 13A. Herein, the access breakdown sub-diagram 1390 is used to depict all IAM identities 1394 permitted to access a specific cloud asset. This sub-diagram may be opened from the options list upon selection of the specific cloud asset.

Herein, a central asset 1392 is depicted at the center of the access sub-diagram, surrounded by the IAM identities 1394 that are configured with access to the specific cloud asset 1392.

Referring to FIG. 14, an exemplary embodiment of a sixth display layout 1400 representing more detailed illustrations of cloud alerts associated with the customer cloud environment of FIG. 11 is shown, Herein, upon selection of the alert display element 1146 of FIG. 11, the interactive menu 1140 features a plurality of alert types to which the cloud platform is susceptible: (1) misconfiguration alerts accessible by selection of a first graphical (filtering) element 1410 (hereinafter, “misconfiguration graphical element”) and (2) NI alerts accessible by selection of a second graphical (filtering) element 1420 (hereinafter, “NI graphical element”). Herein, according to one embodiment of the disclosure, as a default view upon selection of the alert display element 1146, misconfiguration alerts 1430 for various cloud assets populate the workspace 1190. These misconfiguration alerts 1430 are sorted by severity from highest to lowest score.

Herein, the misconfiguration alerts 1430 identify cloud resources or policies, which do not align with best practices or operational guidelines defined by cloud compliance frameworks. Many industry bodies, regulators, and vendors provide frameworks for best practice operations in the cloud, where these frameworks are intended to ensure cloud resources, policies and processes operate as securely as possible. As part of its standard operations, the cloud security system 150 assesses the configuration of assets, policies, and the overall cloud environment against guidelines from many industry compliance frameworks and other assessment criteria. These criteria include general cloud-based best practices not unique to a specific framework, and cybersecurity-provider detections for insecure or unmaintained resource configuration.

Each of the misconfiguration alerts 1430 can range from basic access policy hygiene through to risk-mitigation and core security principles. Hence, each of the misconfiguration alerts 1430 is assigned a severity score 1440, which distinguishes those alerts that present a ‘critical’ risk to cloud environment operations and assists in prioritization of the misconfiguration alerts 1430. When assigned a severity score above a prescribed value (e.g., 70 out of 100), a misconfiguration may be construed as a critical misconfiguration that indicates a severe issue should be addressed and mitigated as a priority. A prioritization section 1445 includes graphical (filtering) elements that identify misconfigurations with different prioritizations and illustrate a count value of these types of misconfigurations. For example, the prioritization section 1445 includes a critical misconfiguration graphical (filtering) element 1450 and count value 1452 that represents all critical misconfigurations which are currently active and detected within a selected time frame (e.g., last seven days). Similarly, the prioritization section 1445 includes a critical NI graphical (filtering) element 1460 and count value 1462 that represents all critical NI alerts which are currently active and detected within the selected time frame.

Upon selecting the critical misconfiguration display element 1450, a listing of critical misconfigurations detected during the selected time frame (e.g., misconfigurations 1454 being a subset of the misconfiguration alerts 1430) is generated and displays on the main workspace 1190. The listing may include the severity scores 1455 assigned to each critical misconfiguration, a description 1456 of the misconfiguration, a number of occurrences 1457 of the misconfiguration detected, and a time of the last detection 1458.

Besides ‘critical’ graphical elements 1450 and 1460, the prioritization section 1445 further includes a suspicious misconfiguration graphical (filtering) element 1470 and count value 1472. The ‘suspicious’ misconfiguration graphical element 1470, when selected, provides a listing of misconfigurations 1459 with a lesser priority in handling or investigating, namely those misconfigurations 1459 with moderate levels of anomaly but do not warrant prioritization over the critical misconfigurations.

When an asset is found to be not compliant with these best practice recommendations, or to be insecure in some way, a misconfiguration alert is raised. The misconfiguration alerts 1430 remain applicable until they are actively resolved, or the affected asset has been removed. As a result, the alerts are timestamped to the last time they were detected as still applicable.

Referring still to FIG. 14, besides misconfiguration alerts, NI alerts may be listed, which highlight unusual, potentially malicious activity emerging within or impacting upon the customer cloud environment. The NI alerts are created from a subset of specialized models. These models are a logic framework that allows operators to interact with the output from ‘pattern of life’ and anomaly classifiers. Models are primarily used to generate alerts to warn on detected anomalous and potentially malicious behavior. When conditions for a model are met, the cloud security system 150 creates a NI alert that highlight and time in which the behavior constitutes an anomalous or potentially anomalous behavior.

Although not shown, upon selection of the NI graphical element 1420, the NI alerts populates the workspace 1190 with alerts for unusual cloud activity or administration, sorted by severity from highest to lowest threat score. Unlike misconfigurations, NI alerts tend to be categorized as critical or not based on the type of detection. NI alerts would feature an additional severity score which can be used to prioritize within the critical category of detection.

Upon selecting the critical NI graphical element 1460, a listing of critical NI alerts (detected during the selected time frame) is generated and displayed on the workspace 1190. The listing may include a name of the critical alert, number of occurrences of the critical NI alert, a target of the critical NI alert, and a time of the last detection.

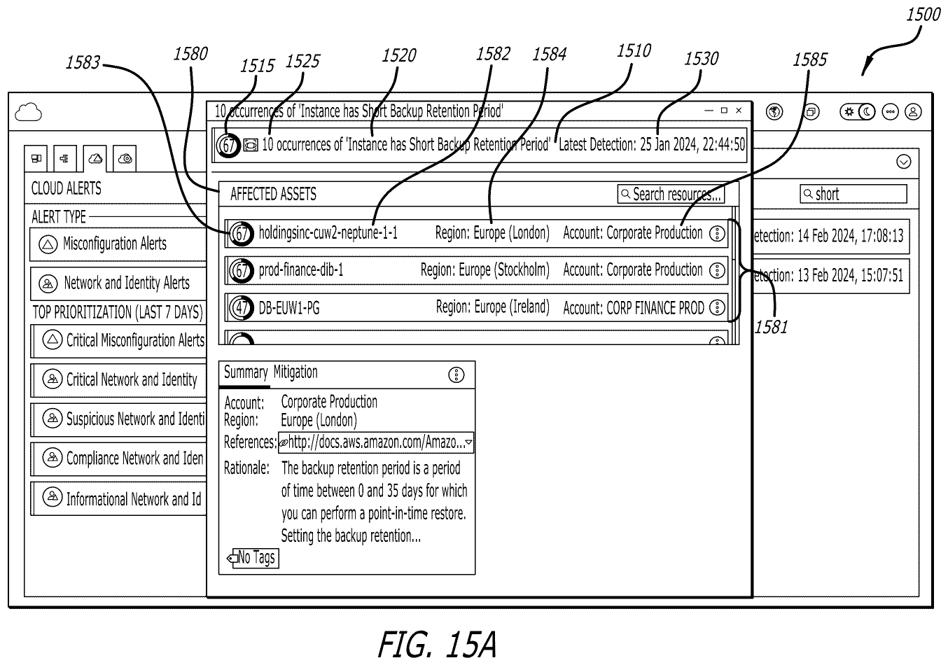

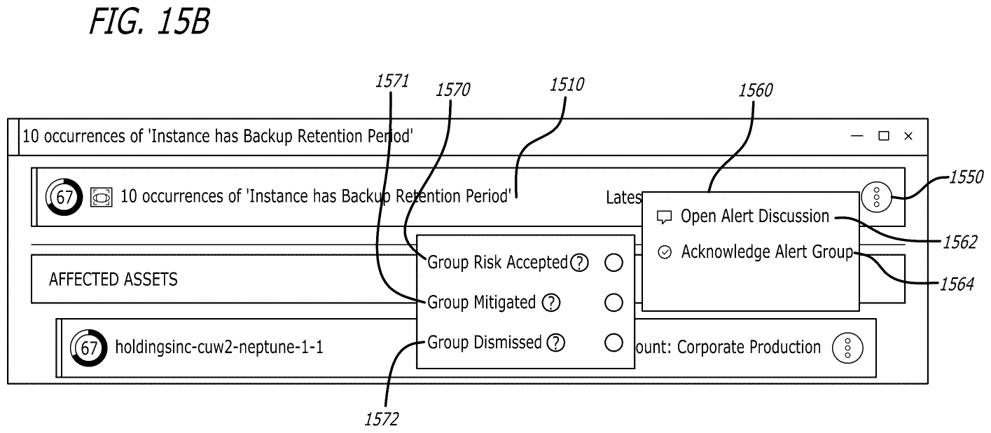

Referring to FIG. 15A, an exemplary embodiment of a seventh display layout 1500 is shown, which represents more detailed illustration of a misconfiguration alert 1510 being one of the misconfiguration alerts 1430 of FIG. 14. To advance one or more detailed illustrations of the misconfiguration alert 1510, an operator may select i) an entry associated with the misconfiguration alert 1510 being one of the misconfiguration alerts 1430 of FIG. 14, ii) an icon situated next to a misconfiguration alert displayed upon selection of the Asset tab 1351 of FIG. 13B, and/or iii) an entry in the Alerts tab 1350 of FIG. 13B. The display layout 1500 may correspond to a pop-out window positioned above the workspace 1190 and provides in-depth information about the activity detected and the assets potentially impacted by a misconfiguration associated with the misconfiguration alert 1510.

As shown, the misconfiguration alert 1510 corresponds to an alert group representing a group of the same misconfiguration present on many cloud assets in the display structure illustrated in FIG. 14. A severity score 1515 of the highest misconfiguration in the group (i.e., 67) is displayed along with a specific description 1520 of the misconfiguration pertaining to the misconfiguration alert 1510, a number of occurrences 1525 of this misconfiguration, and a time of the last (latest) detection 1530. The last detection time 1530 represents the most recent time this alert was still active and applicable. Cloud security system 150 monitors cloud administration tasks through audit activity analysis and regularly re-enumerates the customer cloud environment to detect changes to entities, users, and configuration policies. Misconfigurations may therefore become “resolved”-no longer applicable due to corrections or changes in the environment-which is represented in this last detection time 1530.

As shown in FIG. 15B, an object 1550 positioned proximate to the misconfiguration alert 1510, when selected, provides a display element 1560 with a series of graphical elements directed to actions including “open alert discussion” 1562 and/or “acknowledge alert group.” For the open alert discussions element 1562, users can comment on alerts in the discussion window to provide context or indicate to other users actions undertaken based on the alert. If external communication integrations are in place, the discussion window can also be used to send Microsoft Teams® messages to relevant contacts who can provide additional insight into the misconfigurations.

For the acknowledge alert group element, when selected, alerts can be manually assigned to one of three states manually upon selection of one of the graphical elements: a “group risk accepted” element 1570, a “group mitigated” element 1571 and a “group dismissed” element 1572. Upon selection of a group risk accepted element 1571, the risks associated with the misconfiguration associated with the misconfiguration alert 1510 are accepted by the organization, but the organization does not intend to resolve the misconfiguration at this time due to resource constraints, internal policies, or other reasoning not visible to the cloud security system 150.

The group mitigated state corresponds to a temporary state to mark misconfigurations which have been manually addressed in the customer cloud environment, but the cloud security system 150 has not yet observed the resolution and updated the alert state to “fixed”. For misconfigurations in which the group mitigated element 1571 has been selected, but the cloud security system 150 has not observed the misconfiguration as “fixed,” these misconfigurations will revert to “unresolved” after a prescribed number of days (e.g., 30 days).

The group dismissed state corresponds to an operating state in which an operator considers the alerts to be incorrectly detected-typically these are misconfigurations which have been addressed in some format not visible to the cloud security system 150. For example, the group dismissed may be directed to a policy in place at the software level on the affected instance. Upon selection of the group dismissed state element 1572, a similar alert for this misconfiguration will never be reopened on this asset, even if it continues to be observed when the cloud security system 150 scans the customer cloud environment.

Referring back to FIG. 15A, the display layout 1500 further illustrates an affected assets summary 1580. Herein, each of the misconfigured assets 1581 will appear as an entry in the affected assets summary 1580, where the entry includes a name 1582 of the misconfigured asset, a severity score 1583, and data associated with the misconfigured asset (e.g., region 1584, account 1585, etc.). Misconfiguration severities frequently vary between different affected assets as higher priority asset types or members of higher priority architectures receive higher priority scores.

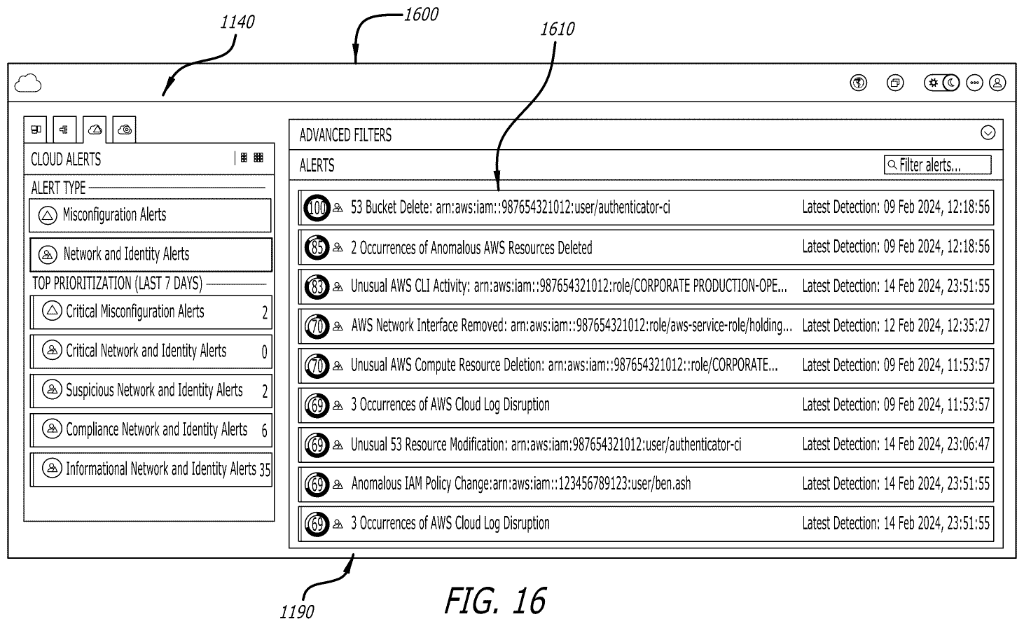

Referring now to FIG. 16, an exemplary embodiment of an eighth display layout 1600 representing more detailed illustrations of network and activity (NI) alerts 1610 associated with the cloud alerts of FIG. 14 is shown. Herein the visualization associated with the display layout 1600 may be derived through monitoring and analysis, where NI alerts highlight unusual, potentially malicious activity emerging within or impacting upon the customer cloud environment. The same element layout for the interactive menu 1140 and workplace 1190 is shown, where the NI alerts may be triggered by IAM entities such as users and roles, where these entities are covered by audit activity monitoring.

The NI alerts 1610 are created for devices covered by network traffic analysis; this includes basic monitoring from flow logs, and deep network monitoring delivered by sensors (e.g., v-sensors, os-sensors, etc.) for correlation with ‘pattern of life’ modeling and anomaly modeling. Models are primarily used to identify and alert on anomalous and potentially malicious behavior. When conditions for a model are met, this creates a model breach and can trigger an alert or action. The NI alerts 1610 populate the workspace 1190 to indicate unusual cloud activity or administration, sorted by severity from highest to lowest threat score.

The format for each entry of the NI alerts 1610 is a similar structure as misconfiguration alerts-severity score, an icon representing the alert type (network or identity), a title describing the activity detected, and a detection time.

Referring now to FIG. 17, a block diagram identifying logical operations performed in creating a cloud remediation plan based on operations performed by the cloud remediation planning component 375 of FIG. 3 is shown. Initially, the cloud remediation planning component 375 operates as an application's user interface to guides a user through several operations in a registration process 1700 to create a cloud remediation plan 1750 that may be specific to a particular security team or security service provided by an entity. First, targeted accounts are selected (block 1710), where the targeted accounts may be specific to the enterprise or subsidiary of the enterprise or may be specific to a particular cloud service provider (e.g., AWS™ Azure®, etc.). Also, targeted architectures may be selected (block 1720), as some security teams may be responsible for only supporting certain cloud architecture(s) (e.g., payment systems, memory storage systems, etc.) or certain group asset type(s) (e.g., EC2 compute engines, S3 storage, etc.). Similar, targeted misconfiguration groups (or rule categories) may be selected, where one security team may be responsible for alerts directed to one or more misconfiguration types or prioritizations (block 1730). Additional granularity may be performed in creating a cloud remediation plan that is focused on account/architecture/misconfiguration types.

In the registration process 1700, besides defining the cloud assets to be assembled in a selected listing (e.g. by account, by architecture, and/or by misconfiguration group), specific users can be added with access permissions to the cloud remediation planning component 380 and communication channels may be directed to assist in communications for effectuating the cloud remediation plan after generation (blocks 1740, 1745 and 1750).

The cloud remediation plan 1750 features i) logic 1760 for access to a data store that is configured to maintain different cloud remediation plan configurations (hereinafter, “access logic 1760”); ii) an activity log 1765; iii) logic 1770 to monitor a level of completion in handling an alert (e.g., Resolved, Investigated, etc.) by security team and/or security team member assignee breakdown; iv) hooking logic 1775 in communication with the cloud module(s) 950 of FIG. 9 to scan for events relating to any of the monitored cloud assets associated with the cloud remediation plan 1750; v) communication logic 1780 to provide information to a ticketing system to include tickets for handling security issues, or the like. The cloud remediation plan 1750 is a framework to receive listing of active alerts categorized based on responsibility for handling so alerts handled by one entity is not listed as pending alerts for another entity.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A cloud security system configured to protect a cloud environment associated with a network, comprising:
a cloud asset enumeration component configured to (i) identify a plurality of cloud assets associated with a cloud architecture and (ii) collect information associated with each of the plurality of cloud assets; and
an asset management component configured to conduct analytics on information associated with the plurality of cloud assets in order to detect misconfiguration of one or more cloud assets of the plurality of cloud assets forming the cloud architecture,
wherein the plurality of cloud assets comprises ephemeral, cloud-based components or services.

2. The cloud security system of claim 1, wherein the cloud asset enumeration component is further configured to conduct access mapping operations by at least determining which cloud asset of the plurality of cloud assets have access to one or more other cloud assets of the plurality of cloud assets.

3. The cloud security system of claim 2, wherein the access mapping operations conducted by the cloud asset enumeration component is configured to collect access criteria associated with user or roles, simulate access restrictions for both identify and access monitoring (IAM) and network policies, mapping routes that exist between one or more cloud assets of the plurality of cloud asset.

4. The cloud security system of claim 1, wherein the cloud asset enumeration component is further configured to (i) create a group of cloud assets from the plurality of cloud assets and (ii) generate an interactive, customer-specific cloud architecture that represents relatedness and interconnectivity of the group of cloud assets.

5. The cloud security system of claim 4 communicatively coupled to a cyber security appliance to generate a first Artificial Intelligence (AI) model based on normal or expected behaviors of the group of cloud assets.

6. The cloud security system of claim 4 further comprising:
a user interface configured to cooperate with (i) a first set of Artificial Intelligence (AI) models trained and configured to model a pattern of life associated with a stable cloud environment and (ii) a second set of AI models trained and configured to model a pattern of life for ephemeral cloud assets.

7. The cloud security system of claim 2 further comprising:
a cloud asset discovery component configured to identify and collect asset property information from one or more queries via an application programming interface (API) of a cloud provider to obtain information associated with one or more cloud assets of the plurality of cloud assets provided by the cloud provider, wherein the information includes available threat intelligence, vulnerabilities associated with the one or more cloud assets, and sensitive information maintained within the one or more cloud assets.

8. The cloud security system of claim 7 further comprising:
an architecture creation component configured with (i) node creation logic to generate node constructs for each of the plurality of cloud assets based on metadata being part of the information collected by the cloud asset enumeration component for each of the plurality of cloud assets, (ii) edge creation logic is configured to generate edge constructs for each communicatively coupled node pair, and (iii) architectural build logic configured to generate at least a cloud architecture construct based on the node constructs and the edge constructs, wherein the cloud architecture construct is a code-based representation for visualization of the cloud architecture.

9. The cloud security system of claim 8 further comprising:
an architecture rendering component configured to generate graphical representations of at least the cloud architecture as determined by the architecture creation component in which where the edges are used to represent relationships and communications between each cloud asset of a group of cloud assets represented as graphical nodes.

10. The cloud security system of claim 1 further comprising:
a user interface configured to cooperate with a cloud remediation planning component to detect misconfigurations or failures to meet best practices in a cloud account for a selected user that is under analysis and collect information associated with the misconfigurations or the failures to meet best practices on a per account basis or on a per logical component basis in order to produce a customer-specific cloud remediation plan.

11. A computerized method comprising:
identifying a plurality of cloud assets within a cloud environment of a customer;
collecting information associated with each of the plurality of cloud assets including metadata associated with a first ephemeral cloud asset of the plurality of cloud assets and metadata associated with a second ephemeral cloud asset of the plurality of cloud assets;
conducting analytics on the metadata associated with the first ephemeral cloud asset and the metadata associated with the second ephemeral cloud asset in order to detect misconfiguration of the first ephemeral cloud asset or the second ephemeral cloud asset;
determining an estimated risk value associated with at least first ephemeral cloud asset and the second ephemeral cloud asset, wherein the estimated risk value associated with the first ephemeral cloud represents a potential risk of the first ephemeral cloud asset being misconfigured and subject to a cyber threat;
generating a visualization of the cloud environment including the first ephemeral cloud asset, the second ephemeral cloud asset, and any relationship links between along with different visualization of the first ephemeral cloud asset and the second ephemeral cloud asset based on the estimated risk values of the first ephemeral cloud asset and the second ephemeral cloud asset.

12. The computerized method of claim 11, wherein the collecting of the information associated with each of the plurality of cloud assets further comprises conduct access mapping operations by at least determining which cloud asset of the plurality of cloud assets have access to the first ephemeral cloud asset and the second ephemeral cloud asset of the plurality of cloud assets.

13. The computerized method of claim 12, wherein the access mapping operations are adapted to collect access criteria associated with user or roles, simulate access restrictions for both identify and access monitoring (IAM) and network policies, mapping routes that exist between one or more cloud assets of the plurality of cloud asset.

14. The computerized method of claim 11, wherein the collecting of the information associated with each of the plurality of cloud assets further comprises (i) creating a group of ephemeral cloud assets including the first ephemeral cloud asset and the second ephemeral cloud asset from the plurality of cloud assets and (ii) generating an interactive, customer-specific cloud architecture visualization that represents relatedness and interconnectivity of the group of ephemeral cloud assets.

15. The computerized method of claim 14 further comprising:
providing information to a cyber security appliance to generate a first Artificial Intelligence (AI) model based on normal or expected behaviors of the group of ephemeral cloud assets.

16. The computerized method of claim 14 further comprising:
generating a user interface configured to cooperate with (i) a first set of Artificial Intelligence (AI) models trained and configured to model a pattern of life associated with a stable cloud environment and (ii) a second set of AI models trained and configured to model a pattern of life for the group of ephemeral cloud assets.

17. The computerized method of claim 12, wherein the identifying of the plurality of cloud assets within the cloud environment further comprises identifying and collecting asset property information from one or more queries via an application programming interface (API) of a cloud provider to obtain information associated with one or more cloud assets of the plurality of cloud assets provided by the cloud provider, wherein the information includes available threat intelligence, vulnerabilities associated with the one or more cloud assets, and sensitive information maintained within the one or more cloud assets.

18. The computerized method of claim 11, wherein the generating of the visualization of the cloud environment comprises (i) generating node constructs for each of the plurality of cloud assets based on metadata being part of the collected information for each of the plurality of cloud assets, (ii) generating edge constructs for each communicatively coupled node pair, and (iii) generating at least a cloud architecture construct based on the node constructs and the edge constructs, wherein the cloud architecture construct is a code-based representation of the visualization of the cloud environment.

19. The computerized method of claim 11, wherein the conducting of the analytics comprises detecting the misconfiguration of the first ephemeral cloud asset or the second ephemeral cloud asset or a failure to meet best practices in a cloud account for a selected user that is under analysis, collecting information associated with the misconfiguration or the failure to meet best practices on a per account basis or on a per logical component basis in order to produce a customer-specific cloud remediation plan.

20. A non-transitory storage medium including software that, upon execution by a processor, is configured to protect a cloud environment associated with a network by detection of misconfigurations of a cloud asset or potential cyber threat against the cloud asset, the software comprises:
a cloud asset enumeration component configured to (i) identify a plurality of cloud assets associated with a cloud architecture and (ii) collect information associated with each of the plurality of cloud assets; and
an asset management component configured to conduct analytics on information associated with the plurality of cloud assets in order to detect misconfiguration of one or more cloud assets of the plurality of cloud assets forming the cloud architecture,
wherein the plurality of cloud assets comprises ephemeral, cloud-based components or services.
